(19) United States
(12) Patent Application Publication
(10) Pub. No.: US 2016/0071117 A1
(43) Pub. Date: Mar. 10, 2016

(54) SYSTEM AND METHOD FOR USING MARKETING AUTOMATION ACTIVITY DATA FOR LEAD PRIORITIZATION AND MARKETING CAMPAIGN OPTIMIZATION

(71) Applicant: FLIPTOP INC., San Francisco, CA (US)

(72) Inventor: Brendan Duncan, La Jolla, CA (US)

(21) Appl. No.: 14/755,396

(22) Filed: Jun. 30, 2015

Related U.S. Application Data
(63) Continuation-in-part of application No. 14/659,566, filed on Mar. 16, 2015.
(60) Provisional application No. 62/048,134, filed on Sep. 9, 2014.

(51) Int. Cl. G06Q 30/02

(52) U.S. Cl. CPC G06Q 30/0201

(57) ABSTRACT

A system and method for using marketing automation activity data for lead prioritization and marketing campaign optimization are disclosed. A particular embodiment uses marketing activity data to predict whether or not the lead will be qualified by sales (lead conversion) and whether the lead will result in a successful sale. In order to reduce the feature dimensionality while maintaining key information about activity types and marketing campaigns, we perform topic modeling to represent activities as a mixture over topics. We then use random forest classification to predict the probability of lead conversion and successful sale. In addition, we map the topic importances assigned by the classifier, to a “Mean Topic Importance” (MTI) score. We confirm that the relative MTI scores of different activities are intuitive. These MTI scores can be used to give marketing teams information about which marketing campaigns and assets are more important for a lead prioritization model.

### PRIORITY PATENT APPLICATIONS

This is a continuation-in-part patent application drawing priority from co-pending U.S. non-provisional patent application Ser. No. 14/659,566; filed Mar. 16, 2015; which draws priority from co-pending U.S. provisional patent application Ser. No. 62/048,134; filed Sep. 9, 2014. This present continuation-in-part patent application draws priority from the referenced patent applications. The entire disclosure of the referenced patent applications is considered part of the disclosure of the present application and is hereby incorporated by reference herein in its entirety.

### TECHNICAL FIELD

This patent application relates to computer-implemented software and networked systems, according to one embodiment, and more specifically, to a system and method for using marketing automation activity data for lead prioritization and marketing campaign optimization.

### BACKGROUND

Lead scoring is a well-known technique for determining the quality of sales leads received or generated by a business. Many companies use a manual, hand-tuned lead scoring system, which is time consuming to construct and error-prone. Such methods are generally used by the marketing team of a business to determine marketing qualified leads (MQLs). Marketing automation software facilitates the creation of such lead scoring systems. Although the potential benefit of marketing automation has been recognized since at least 1989, according to some sources, only 40% of sales teams with marketing automation think that their marketing automation adds value. Therefore, such systems still result in low quality MQLs being handed off to sales teams, making the sales qualification process expensive, less efficient, and time consuming.

Marketing automation software is increasingly being used by marketing teams in order to automate repetitive tasks, and organize marketing campaigns over different channels, such as social media, email, phone, websites, blogs, and webinars. Most systems keep track of the marketing team's interaction with individual potential customers called leads. For example, if a lead visits a website, fills out a form, or downloads a white paper, this would be recorded by marketing automation. Marketing automation also facilitates sending mass emails to leads, and records whether the emails are opened, or whether customers clicked on links within the email. Marketing automation software collects a large amount of data in the marketing automation process. However, the value of this data has not been applied to lead prioritization and marketing campaign optimization by conventional systems.

### BRIEF DESCRIPTION OF THE DRAWINGS

The various embodiments are illustrated by way of example, and not by way of limitation, in the figures of the accompanying drawings in which:

FIG. 1 illustrates an example embodiment of a system and method for using marketing automation activity data for lead prioritization and marketing campaign optimization;

FIG. 2 shows a traditional sales funnel. The different cross sections of the funnel represent different stages as the lead moves forward in the sales process. The decreasing diameter of the funnel represents a smaller and smaller volume of prospects;

FIG. 3 illustrates Table 1, which shows some potential values that might be assigned for different behaviors and attributes;

FIG. 4 illustrates an example embodiment showing how leads are sorted, with lower leads having more activities. The x-axis is position in the sort, and the y-axis is the corresponding number of activities for that lead;

FIG. 5 illustrates Table 2, which shows applying the DQM to Company A data resulting in the AUC (Area Under Curve) metrics;

FIG. 6 illustrates Table 3, which shows AUC scores for the FFM metric;

FIG. 7 shows closed won lift curves for leads prioritized according (α, β)=(0, 1);

FIG. 8 illustrates conversion and close won lift curves for FFM if we prioritize leads according to their expected revenue;

FIG. 9 illustrates the revenue lift curve for FFM;

FIG. 10 illustrates Table 4, which shows a comparison of the conversion, revenue, and close won rates if the companies prioritize leads randomly, using DQM, and using FFM;

FIG. 11 illustrates a comparison of the closed won rates for DQM (with (α, β)=(0, 1)) and FFM built using all behavioral and static features;

FIG. 12 illustrates a comparison of the revenue lift curves for FFM and DQM;

FIGS. 13 and 14 are processing flow charts illustrating example embodiments of methods as described herein;

FIGS. 15 and 16 are processing flow charts illustrating other example embodiments of methods as described herein;

FIG. 17 shows the Receiver Operating Characteristic curves (or ROC curves) for a sample Company B;

FIG. 18 shows the conversion and closed won rates if we group them into deciles based on the predicted probability of closed won;

FIG. 19 shows the calibration of probabilities within the deciles;

FIG. 20 illustrates the ROC curves for the naive activity features in an example embodiment;

FIG. 21 is a processing flow chart illustrating another example embodiment of the methods as described herein; and

FIG. 22 shows a diagrammatic representation of a machine in the example form of a stationary or mobile computing and/or communication system within which a set of instructions when executed and/or processing logic when activated may cause the machine to perform any one or more of the methodologies described and/or claimed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

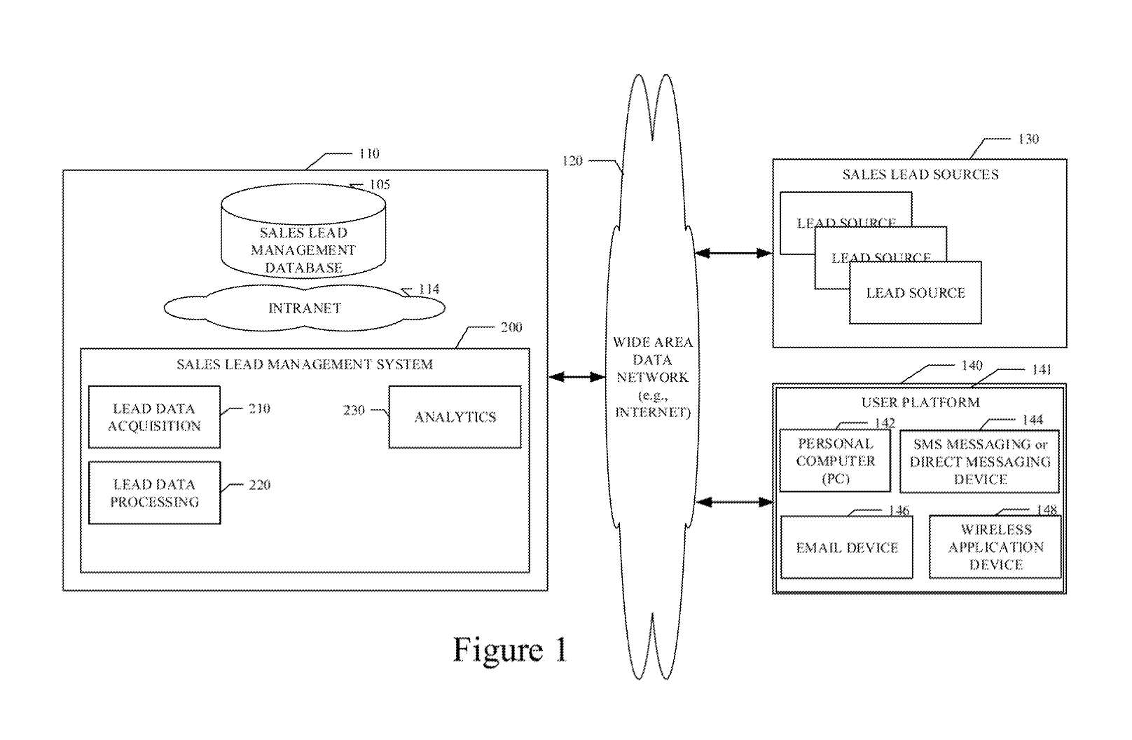

Referring to FIG. 1, in an example embodiment, a system and method for using marketing automation activity data for lead prioritization and marketing campaign optimization are disclosed. In various example embodiments, an application or service, typically operating on a host site (e.g., a website) 110, is provided to simplify and facilitate sales lead management for a user at a user platform 140 from the host site 110. The host site 110 can thereby be considered a sales lead management site 110 as described herein. In the various example embodiments, the application or service provided by or operating on the host site 110 can facilitate the downloading or hosted use of the sales lead management system 200 of an example embodiment. In a particular embodiment, the sales lead management system 200, or a portion thereof, can be downloaded from the host site 110 by a user at a user platform 140. Alternatively, the sales lead management system 200 can be hosted by the host site 110 for a networked user at a user platform 140. Multiple lead sources 130 can provide a plurality of sales leads, which may produce conversion to a sales opportunity. It will be apparent to those of ordinary skill in the art that lead sources 130 can be any of a variety of offline or online (networked) sales lead sources, email marketing services, social network sources, or sales lead aggregators as described in more detail below. For example, lead sources 130 can include social media channels, such as Facebook, Twitter, or YouTube, or email marketing sites, such as MailChimp, Constant Contact, or ExactTarget. The sales lead management site 110, lead sources 130, and user platforms 140 may communicate and transfer leads and information via a wide area data network (e.g., the Internet) 120. Various components of the sales lead management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The lead sources 130 may include any of a variety of providers of network transportable digital content. Typically, the file format that is employed is XML, however, the various embodiments are not so limited, and other file or data formats may be used. For example, data feed formats other than HTML/XML or formats other than open/standard feed formats can be supported by various embodiments. Any electronic file format, such as Portable Document Format (PDF), text, audio (e.g., Motion Picture Experts Group Audio Layer 3—MP3, and the like), video (e.g., MP4, and the like), and any proprietary interchange format defined by specific content sites can be supported by the various embodiments described herein.

In a particular embodiment, a user platform 140 with one or more client devices 141 enables a user to access information from the lead sources 130 via the network 120. Client devices 141 may include virtually any computing device that is configured to send and receive information over a network, such as network 120. Such client devices 141 may include portable devices 144 or 146 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 141 may also include at least one client application (app) that is configured to receive data or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 141 may also include a wireless application device 148 on which a client application is configured to enable a user of the device to receive leads from at least one lead source 130. As such, the user at user platform 140 can receive leads through the client device 141. Moreover, the lead data may be provided to client devices 141 using any of a variety of delivery mechanisms, including IM, SMS, Twitter, Facebook, MMS, IRC, EMS, audio messages, HTML, email, or another messaging application. In a particular embodiment, the client application executable code used for sales lead management as described herein can itself be downloaded to the wireless application device 148 via network 120.

Referring still to FIG. 1, host site 110 of an example embodiment is shown to include a sales lead management system 200, intranet 114, and sales lead management database 105. Sales lead management system 200 includes lead data acquisition module 210, lead data processing module 220, and analytics module 230. Each of these modules can be implemented as software components executing within an executable environment of sales lead management system 200 operating on host site 110 or on a user platform 140. Each of these modules of an example embodiment is described in more detail below in connection with the figures provided herein.

Referring still to FIG. 1, lead data acquisition module 210 can be in data communication with the plurality of lead sources 130, one or more portions of data storage device 105, and the other processing modules 220 and 230 of the sales lead management system 200. In general, the lead data acquisition module 210 is responsible for enabling a user system or account to receive sales lead data of interest from any of the variety of lead sources 130. The lead data acquisition module 210 can also be considered a web front end module that can interact with users via a graphical user interface and with lead sources via application programming interfaces (API's) as described in more detail below.

In a particular embodiment, lead data acquisition module 210 can be configured to interface with any of the lead sources 130 via wide area data network 120. Because of the variety of lead sources 130 providing sales leads to lead data acquisition module 210, the lead data acquisition module 210 may need to manage each lead source 130. This lead source management process includes retaining information about each lead source 130, including an identifier or address of the corresponding lead source 130, the timing associated with the lead source 130, including the time when the latest content update was received and the time when the next update is expected, and the like. This lead source information can be stored in lead database 105.

Referring still to FIG. 1, the lead data processing module 220 is responsible for automatically processing the lead data received by the lead data acquisition module 210 in ways to make the lead data useful and informative for the user. The lead data processing module 220 can use a batch controller to collect or aggregate the lead data in off-line processes. The lead data processing module 220 can also be considered a back end module that can interact with lead sources in an off-line mode via application programming interfaces (API's) as described in more detail below. The processed sales lead information can be stored in lead database 105.

Referring still to FIG. 1, the analytics module 230 can be used by the lead data processing module 220 to generate, among other information and metrics, ranking data related to sales leads. In the example embodiment disclosed herein, a process is described for creating a probabilistic model for a sales funnel. The lead data processing module 220 and/or the analytics module 230 can be used to implement this process in an embodiment. This process in an example embodiment is described in more detail below.

### Creating a Probabilistic Model for a Sales Funnel

In an example embodiment, we introduce two models, DQM (direct qualification model) and FFM (full funnel model), which can be used to rank sales leads based on probability of conversion to a sales opportunity, probability of successful sale, or expected revenue. For training, we make use of the large amount of historical data collected by customer relationship management systems, such as the Salesforce CRM and marketing automation software, such as Marketo and Eloqua. These models, as disclosed here for example embodiments, can replace traditional, manually created lead scoring systems, which use hand-tuned scores and are therefore error-prone and non-probabilistic. We have designed DQM and FFM to overcome selection bias resulting from conventional lead scoring systems. In the example embodiment, experimental results are performed on actual sales data from two companies. The training data was provided by Fliptop (http://www.fliptop.com), and consists of data collected by Salesforce CRM and Marketo marketing automation software, along with proprietary features appended by Fliptop. These features include demographic and behavioral information about each lead. These methods achieve high AUC scores in our experiments, and we show that they can result in a 137% increase in conversion rate, a 307% increase in successful sale rate (for company A), as well as dramatic increases in total revenue. Unlike traditional lead-scoring, our methods provide an intuitive probabilistic score, and focus more on features that measure customer fit than customer behavior, meaning quality leads can be found earlier on in the sales process.

Customer relationship management systems and marketing automation software have become popular tools for companies with sales and marketing teams. Because these systems store a large amount of historical sales data, they also provide great potential for machine learning processes to improve the sales process. Companies can use a predictive sales lead scoring or ranking model to prioritize sales and marketing efforts towards leads that will be more likely to result in successful sales.

### The Sales Funnel and Lead Scoring Motivation

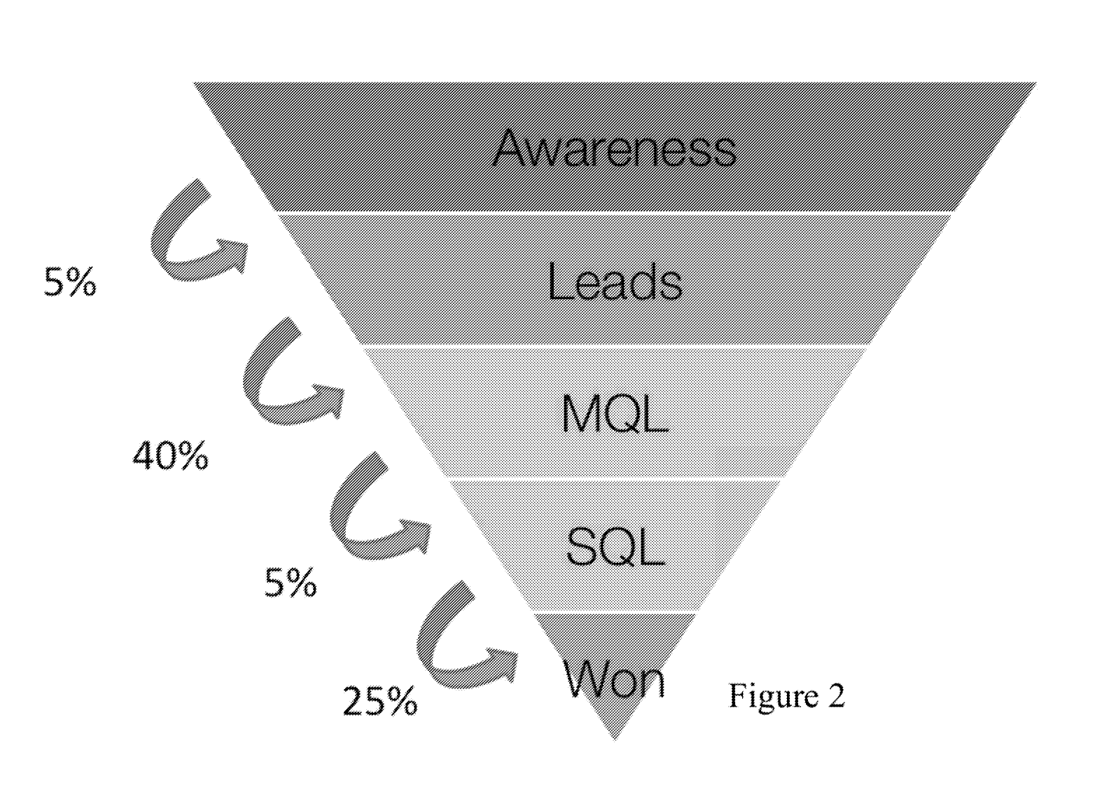

FIG. 2 shows a traditional sales funnel, which is a popular model for representing how potential customers move through the marketing and sales process. The different cross sections of the funnel represent different stages as the lead moves forward in the sales process. The decreasing diameter of the funnel represents a smaller and smaller volume of prospects. We see from the image that there are a large number of leads, but only a small number of SQLs (sales qualified leads).

### Leads

In FIG. 2, a “lead” represents a prospect that has not been qualified in any way. For example, when an individual visits a website, or exchanges contact information with the marketing team, they will begin to be tracked by marketing automation software, as a “cold lead.”

### MQLs

As leads are tracked by marketing teams (and marketing automation software), marketing will determine scores for leads, based on the amount of interest they show in the product (behavioral information) and their demographic fit for purchasing the product (demographic information). Leads that are determined to be qualified based on these marketing criteria will be passed onto the sales team as “marketing qualified leads.”

### SQLs

Once the sales team receives leads from marketing, there is an additional qualification step. “Teleprospectors” will reach out to the individuals and determine if the individual meets the minimum criteria for becoming a sales opportunity. For example, the person must be in the market for the solution offered by the company, and must have the authority and budget to purchase the product within the sales timeline requirements. If an individual meets these criteria, they are qualified and become a “sales qualified lead” or SQL, and can be converted to a sales opportunity. This is called “lead conversion.” The majority of SQLs will be pursued by sales representatives, and will either result in a successful sale (closed won), or a failed sale (closed lost). According to some sources, only 6% of MQLs will convert to closed won opportunities. A major expense to sales teams is the time wasted on dealing with a large volume of low quality MQLs that will not be qualified. In many cases, there will be more leads than can be prospected by the current sales team. Instead of hiring more teleprospectors, or arbitrarily choosing a subset of leads to pursue, sales teams can instead prioritize their efforts on those leads that are most likely to qualify.

A predictive model can be employed for this prioritization. It can predict the probability of conversion, the probability of closed won, or the expected revenue of a given lead. The last of these allows a sales team to estimate the amount of sales and marketing funds that should be allocated to deal with particular leads.

The most expensive parts of the funnel are the sales qualification and the actual sales (sales representatives pursuing opportunities), since they require the most manual work either by teleprospectors or sales representatives. Therefore, a predictive model can add the most value for these two steps of the funnel. Although the example embodiment focuses on predicting lead conversion, FFM is also directly applicable to ranking sales opportunities.

Other reports of data mining techniques for sales and marketing include (Bose and Mahapatra 2001) and (Berry and Linoff 2004), which book includes a chapter on identifying prospects using a CRM. Other analysis of using predictive techniques to gain insights into consumer behavior and improve marketing operations are given in (Shaw et al. 2001), and (Cui, Wong, and Lui 2006).

### Conventional Lead Scoring

Lead scoring is not new; many companies use a manual, hand-tuned lead scoring system, which is time consuming to construct and error-prone. Such methods are generally used by the marketing team to determine MQLs. Marketing automation software facilitates the creation of such scoring systems. Although the potential benefit of marketing automation has been recognized since at least 1989 (Moriarty and Swartz 1989), according to SiriusDecisions, only 40% of sales teams with marketing automation think that their marketing automation adds value. Therefore, such systems still result in low quality MQLs being handed off to sales teams, making the sales qualification process expensive and time consuming. In this section we discuss these conventional methods and examine their disadvantages.

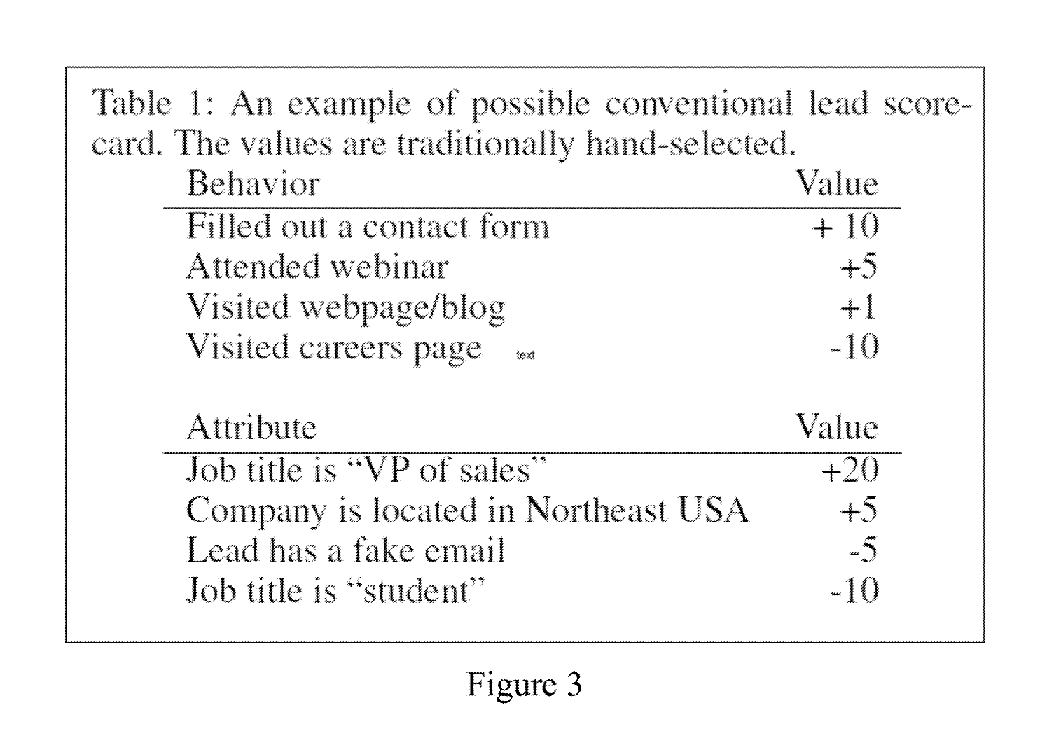

Previously, companies that wanted to prioritize leads relied on a manual lead scoring system. These scores would be hand-tuned by experienced members of the marketing or sales team. In such systems, a “scorecard” scoring system is used, in which the presence or absence of certain positive or negative customer attributes or behaviors are assigned fixed positive or negative values. These individual values are then summed to determine a final score for the lead. For example, Table 1 (illustrated in FIG. 3) shows some potential values that might be assigned for different behaviors and attributes.

One issue with conventional lead scores is that they fail to capture nonlinear correlations. For example, if a user visits many webinars, they will receive a high lead score, since they accumulate 5 points for each webinar. However, there may be diminishing returns for each webinar visit. The highest quality leads may visit, say, between two and four webinars; attending additional webinars past this may not indicate a significant probability of making a purchase. It may even be the case that visiting many webinars is a negative signal. For example, it could indicate the behavior of a student, or even a competitor, who is researching the marketing functions of the company. In addition, complex interactions of features cannot be represented by such models.

Another issue with conventional lead scoring is that the hand-selection of values is error-prone, time consuming, and non-probabilistic. Hand-selection also allows for bias from potentially mistaken business logic. An example of selection bias would be the following: if a company focuses its sales efforts on, say, customers in Florida, a machine learning model might then learn that being based in Florida is a positive signal for a lead. Similarly, if leads are qualified or prioritized based on conventional lead scoring, machine learning models could in effect “relearn” these simple linear scorecards, and therefore maintain the selection bias that is present in the existing, hand-tuned model. In the motivation of our processes, we describe how our design attempts to reduce the contribution of selection bias.

A third disadvantage is that these traditional lead scores are unbounded positive or negative values. They do not intuitively map to the probability of lead conversion or opportunity close. Machine learning methods are probabilistic and therefore can give intuitive probability scores.

The final, and most serious disadvantage, is that these systems are often heavily reliant on behavioral data. While such data can be a good indicator of lead interest in the product, it prevents discovering the high quality leads early; they will only be found after enough time has passed for the lead to have taken specific actions. To avoid reliance on behavioral data, one could try to gather additional static features about the customer, but each additional feature adds complexity for hand-selecting an appropriate value.

### Goals for Lead Scoring

The criteria for lead qualification vary greatly by company. When marketing qualifies a lead, it is usually based on simple behavioral and demographic rules. The demographic rules depend on the product of the company, and user interaction with the marketing materials specific to the company. As we saw before, determining MQLs is an error-prone process.

Since the volume of MQLs is often greater than can be handled by the sales team, the sales team will have to either prioritize leads based on more non-probabilistic rules, or hire more teleprospectors for sales qualification. Even if there is not such a great volume of leads, teleprospecting low-quality MQLs results in wasted time, and is a cause of tension between the sales and marketing teams. This tension is a serious problem in many companies, and is the subject of research, such as (Kotler, Rackham, and Krishnaswamy 2006).

Because of the potentially flawed marketing qualification, and the arbitrary prioritization of MQLs by the sales team, there is a large amount of selection bias in the earlier stages of the sales funnel. On the other hand, it is likely that all sales opportunities are pursued by sales representatives. Therefore, there is little selection bias in the later stages of the funnel. This is a major reason why predictive models should be trained with information from later stages of the funnel. The other reason is that the ultimate goal of the sales funnel is to close a successful sale, even if the problem at hand is simply to find leads that are more likely to be qualified by sales.

In the design of the models described in the example embodiment herein, we address several major goals:
1. The model should be probabilistic and have a meaningful interpretation, such as expected revenue or probability of successful close.
2. The models should not simply relearn the existing conventional lead classification model.
3. The models should be consistent with a separate opportunity won/lost classification model. That is, they should assign higher scores to leads corresponding to closed won opportunities than leads which convert but are not successfully closed.
4. The model should be able to find quality leads quickly, without relying too heavily on activity data.

Our design of the models in an example embodiment accomplishes goals 1, 2 and 3 listed above. Goal 4 is really the result of having good static (non-behavioral) features. We perform experiments using the Direct Qualification Model (DQM) to show that the method performs well without activity features. The Full Funnel Model (FFM) has additional advantages:
1. It works well with a certain type of missing data (described further in the “Motivation” section for FFM below).
2. It can be used to compute the expected revenue of a lead. This means that companies can prioritize by expected revenue, and know how much is reasonable amount of money to dedicate to pursuing each lead.
3. FFM has “built-in” models for scoring sales opportunities, in addition to scoring leads.

### Data

The data in our experiments consists of sample sales and marketing data extracted from Salesforce and Marketo, to which additional features have been appended. As with conventional lead scoring, the type of features present are of broadly two kinds: static (or fit) features and behavioral (or activity) features. The static features are demographical information about either the individual contact or the company for which the individual works. Examples would be information about customer location, number of employees, the contact's job title, industry type, number of open job postings for different departments, and about the technologies used by the customer, and represent the “fit” of the individual and the product. Behavioral features represent actions taken by an individual. For example, the number of times a lead has visited a product website, or whether the lead has filled out a particular form. All of the behavioral features are represented as counts, while the majority of the static features are binary or categorical variables.

The remainder of this section describes the historical lead data for two sample companies, “Company A” and “Company B,” which is used in our experiments. For additional information on the data preprocessing used for our experiments, see sections “Training sets and classifiers” set forth below.

### Company A

In the example embodiment described herein, “Company A” is a privately owned SaaS company. The training set for Company A consists of 5925 unconverted leads, 1320 leads that became closed lost opportunities, and 1469 leads that became closed won opportunities. For this company, we have collected 243 static company and lead level features, along with 350 behavioral features. The median close price of a sale is $99, and the mean close price is $9930. The mean is 100 times the median because the pricing varies greatly based on product type and number of software licenses sold.

### Company B

In the example embodiment described herein, “Company B” is a publicly owned software company. The training set for Company B consists of 25904 unconverted leads, 956 leads that became closed lost opportunities, and 1097 leads that became closed won opportunities. For this company, we have collected 242 static company and lead level features, along with 20 behavioral features. The median close price of a sale is $29618, and the mean close price is $46118.

### DQM

The DQM (direct qualification model) models a sales funnel using a single classifier. Leads will receive different class labels depending on how far along in the sales funnel they progress. We first describe the motivation for such a model, then give details on how to construct and label a training set, and then describe the classification process.

### Motivation

Predicting whether a lead will convert is a binary classification problem, and would seem to require only training a binary classifier. There are several reasons why this is undesirable for lead qualification.

The main reason is that this would run the risk of simply re-learning the conventional lead scoring model that the company uses. Since the lead scoring models are typically simple scorecards with linear weights, machine learning models should be able to predict lead conversion with high accuracy. However, this will not add additional benefit to the sales team, and the quality of the leads selected will be dependent on the quality of the hand-tuned weights.

Another disadvantage to a two-class solution is that, intuitively, a lead that makes it further through the sales funnel is of higher quality than one that does not. Therefore, we really would like our score to incorporate some information about likelihood of a lead to end up as a successful sale. A naive converted vs non-converted classifier cannot incorporate this information.

If our lead conversion score incorporates closed won probability information, it is also more likely that the score will be consistent with a separate predictive model that ranks sales opportunities, if one is used. That is, if lead A has a higher score than lead B, and both leads convert to opportunities A and B, we would like opportunity A to also have a higher score than opportunity B, according to an opportunity scoring model.

We can address all these potential disadvantages by classifying leads into three classes of disposition as follows:

NoCON: Leads that never convert

LOST: Leads that convert to opportunities that are ultimately lost

WON: Leads that convert to opportunities that successfully close (closed won).

### Training Set and Classifier

For classes LOST and WON, we include only leads that close within the last year, so that the model is up-to-date (the numbers given in the “Data” section are after we have performed all the filtering described in this section).

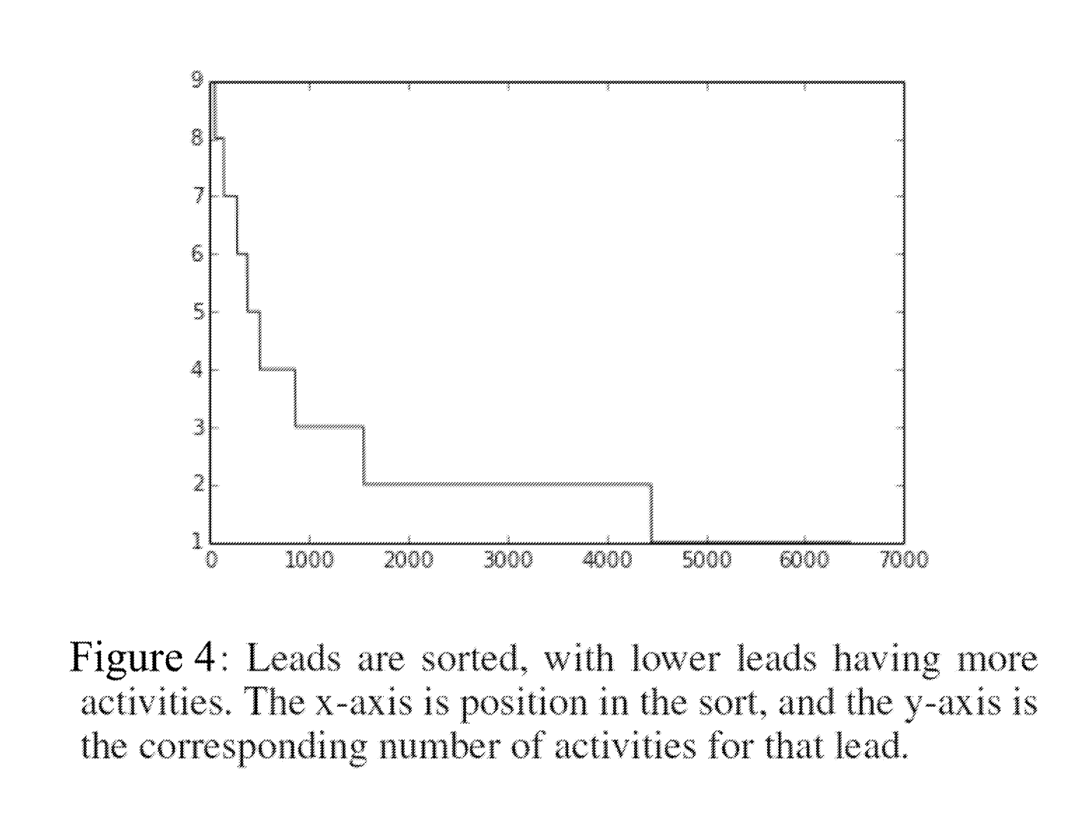

For behavioral features, we ensure that the only the first year's worth of behavioral features is included (for most leads there is much less data than this). In addition, we only include activities which occurred before conversion, and remove certain marketing activities that indicate actions taken by the marketing team (such as administrative or data management actions) rather than by the actual customer. As shown in FIG. 4, leads are sorted, with lower leads having more activities. The x-axis is position in the sort, and the y-axis is the corresponding number of activities for that lead. This type of sorting is typically performed for training purposes. More specifically, this sorting is typically performed only for training to filter out some leads that have very few corresponding activities.

For class NoCON, we simply use all leads that have not yet converted. While this class may contain a small number of leads that will eventually convert, we found that this did not greatly affect the performance of our method. Another option would be to treat the non-converted leads as unlabeled, and use a positive-only learning method, such as (Elkan and Noto 2008).

For company A, the great majority of non-converted leads have fewer than 2 activities, and similar features in general, meaning that a model could achieve high accuracy by simply identifying this great majority of unconverted leads. In order to show that our methods work well for companies with more variety in class NoCON, we include all the leads with more than one activity, and a number L₁ of leads with less than two activities, such that L₁ is roughly equal to the number of leads with exactly 2 activities.

Although this changes the distribution of leads, and therefore also changes the calibration of probabilities, this filtering of the training set is not unlike the process of clearing unpromising leads out of a leads database. Some companies will be more aggressive with deleting leads, so our method must work with different procedures.

### Classifier

In an example embodiment, we use a 3-class gradient boosting classifier ((Friedman 2001), (Friedman 2002)). For the experiments as described herein, we use the implementation from scikit-learn (Pedregosa et al. 2011), with the default parameters.

### Lead Scoring

After training the classifier on the training set, we can use it to perform prediction on a separate test set. For each lead x to be scored in the testing set, the classifier will give us the probabilities: p₁(x)=P(l(x)=NoCON), p₂(x)=P(l(x)=LOST), and p₃(x)=P(l(x)=WON), where l(x) denotes the label of x.

There are several ways to map this into a lead score, s(x). We only consider methods that involve a linear combination of p₁ and p₂:

s(x)=αp₁(x)+βp₂(x).

After some linear combination is determined, leads can be sorted based on their score. For possible linear combinations, we only tried (α, β)=(0, 1), and (α, β)=(1, 1). These correspond to maximizing closed won probability, and maximizing lead conversion probability, respectively. Other weightings are possible, but they would not directly correspond to intuitive probability scores.

### FFM

Rather than using three classes and a single classifier, FFM uses two binary classifiers along with an optional regressor. FFM is described in more detail below.

### Motivation

FFM stands for “full funnel modeling”. As a lead advances in the sales funnel, it moves through several stages (see FIG. 2). The conversions we are most interested in are lead->SQL (lead conversion), and SQL->closed won. We can represent these conversions using two models:

P(lead->SQL|x): (1)

P(lead->closed won|lead->SQL,x): (2)

Additionally, we can include a third layer to model as set forth below:

E(sales price of lead|SQL->closed won,x): (3)

In these equations, x denotes the features for a given company. This allows us to predict the probability that a lead will be a successful sale, as shown below:

P(lead->closed won|x)=P(lead->SQL|x)*P(lead->closed won|lead->SQL|x).

We can also compute the expected revenue of the lead, as shown below:

E(revenue of x)=P(lead->closed won|x)*E(sales price of lead|SQL->closed won,x)

This allows a sales team to better estimate how much money should be invested in pursuing each lead.

FFM can also make predictions involving SQLs. For example, P(lead->closed won|lead->SQL, x) is directly provided by the model, and E(revenue of SQL) can be computed as shown below:

P(lead->closed won|lead->SQL,x)*E(sales price of lead|SQL->closed won,x).

Separating the conversion classifier and the closed won classifier also results in another advantage of FFM. It is often the case that the leads data and sales opportunity data are stored in separate databases. In some cases, missing fields make it difficult to link up a lead with its corresponding opportunity, and vice versa. In such a case, a complete FFM can be learnt, while a DQM cannot, as we will not know whether to label converted leads as class WON or class LOST.

### Training Sets and Classifiers

The filtering and preprocessing of lead features is the same as that described in the corresponding section under DQM; but, the training sets and labels differ. FFM requires the construction of three training sets: a training set of leads for modeling P(lead->SQL|x) a training set of opportunities for modeling P(lead->closed won|lead->SQL, x), and a training set of closed won leads to model E(sales price of lead|SQL->closed won, x). We use the same classifier and parameters as in the DQM model, but for binary instead of 3-class classification. For regression, we also use gradient boosting.

### Lead Scoring

Lead scoring in general is described in the corresponding section above under DQM. For FFM, we compute s(x) as either s(x)=P(lead->closed won|x) or s(x)=E(revenue of lead|x). The former definition of s(x) is analogous to setting (α, β)=(0, 1) for DQM. Therefore, the model is less flexible because it cannot weigh predicted classification and predicted close. Since the former definition is analogous to DQM while being less flexible, our experiments only consider scoring based on expected revenue of leads.

### Experimental Results

The data we use in this experiment is described in the “Data” section above. For training, we use a 75%/25% training/test split of the data. Experiments for DQM report two scalar evaluation metrics: AUC₁, the area under the ROC curve (AUC) for classification of non-converted vs converted leads (that is, class NoCON vs class [WON or LOST]), and AUC₂, the AUC for the classification of leads that become closed won opportunities vs. those that do not (that is, class [NoCON or LOST] vs class WON). For FFM we use AUC for the two separate classifiers, which model conversion rate and close won rate.

As another test of score quality, we plot lift curves for each of the experiments, which show the ratio of converted or won leads as we increase the selection rate. We also include lift curves which show the proportion of possible revenue as we increase the selection rate.

### AUC Results

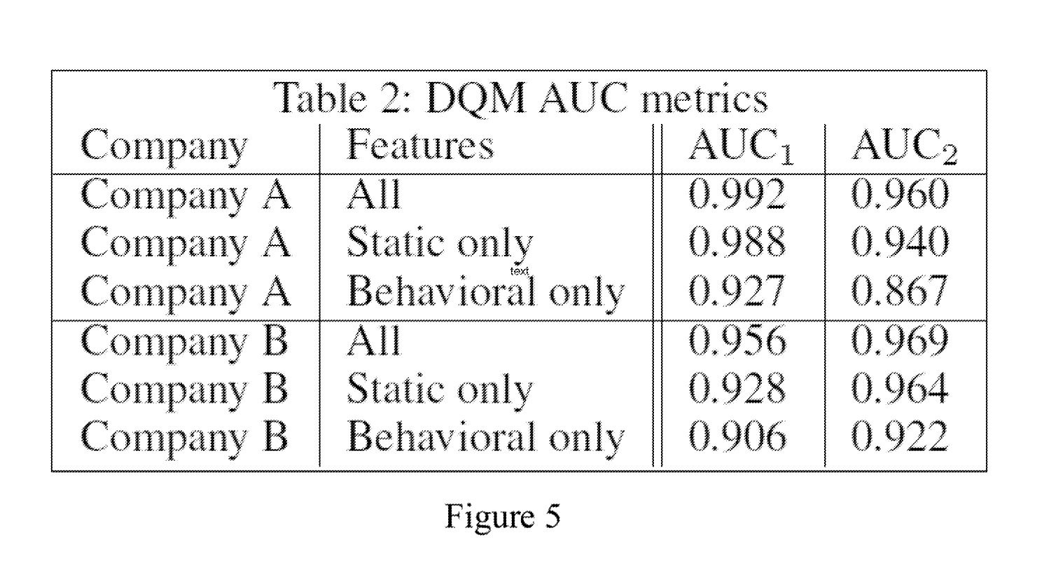

Applying the DQM to Company A data results in the AUC metrics given in Table 2 as shown in FIG. 5. In order to see how the different types of features contribute to the model, we give AUC metrics for a model built with all the features, one built with only behavioral features, and one built with only demographic (“static”) features. Note that the AUC₁ scores are high. This is likely because the model can easily learn the existing business rules, such as a linear scorecard for qualifying leads. The way these models can add value over existing metrics is by using other criteria to prioritize leads, which is examined in revenue and win rate “lift curves” below.

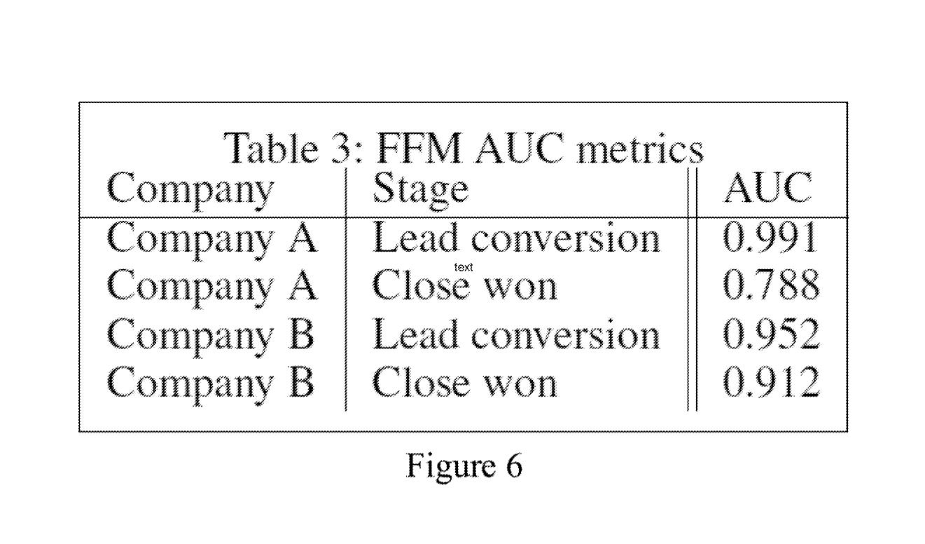

AUC scores for the FFM metric are given in Table 3 as shown in FIG. 6. We give the AUC measures for the two classifiers: for predicting lead->SQL conversion, and predicting MQL->close won. Because of space constraints, we do not repeat the comparison of static vs behavioral features for FFM, and all FFM experiments use all behavioral and static features.

### Comment on “Lift Curves”

To visualize the performance of DQM and FFM, we use “lift curves” that differ from traditional lift curves, because the criteria of ordering leads can differ from the quantity measured in the y-axis. For example, the DQM always prioritizes leads in the same order, based on its scores s(x) (as described herein, s(x) corresponds to predicted probability of close won, since we are using (α, β)=(0,1)). With this same ordering, we compute lift curves that track the proportion of successful sales, and proportion of revenue. Similarly, our experiments for FFM all rank leads based on expected revenue, but we include lift curves that track proportion of conversions, successful sales, and proportion of revenue.

### DQM Experiments

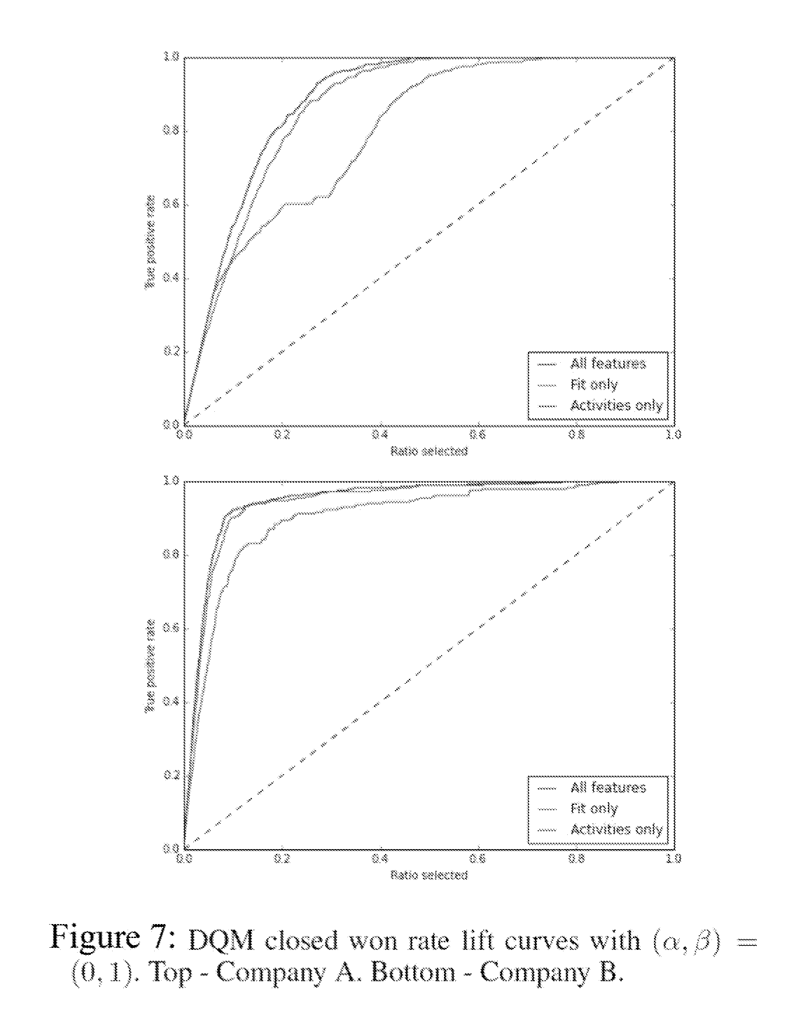

FIG. 7 shows closed won lift curves for leads prioritized according (α, β)=(0,1). It compares the model obtained from using all features, using just behavioral features, and using just static features. For company A, we see that using all features performs best, while using behavioral features alone performs worst. For company B, different features perform better for different selection rates. In this experiment, we see that all features together perform best in general, and the activities features perform worst overall.

We also ran experiments with (α, β)=(1,1). This corresponds to a sort that reduces the probability of class 1 as we move from group 1 to group 10. Because of this, as might be expected, we observe that the conversion line performs better than the previously, but the closed won curves are significantly worse. We are concerned with adding value to the sales team, so the (α, β)=(1,1) sort is less desirable than the previous sort; because, the leads with label WON ultimately should represent the highest quality leads. We do not include the experiments with (α, β)=(1,1) in the description herein.

### FFM Experiments

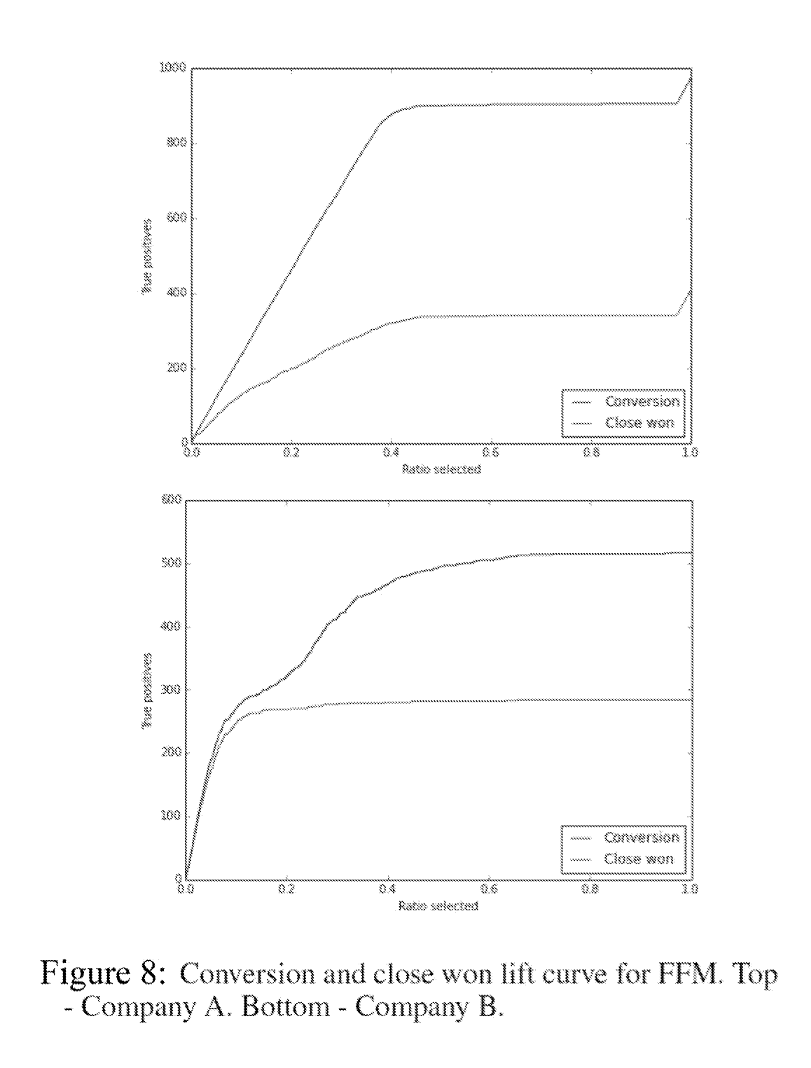

In FIG. 8, we illustrate conversion and close won lift curves for FFM if we prioritize leads according to their expected revenue as shown below:

(E(revenue of lead)=E(sales price of lead|MQL->closed won)*P(lead->closed won)).

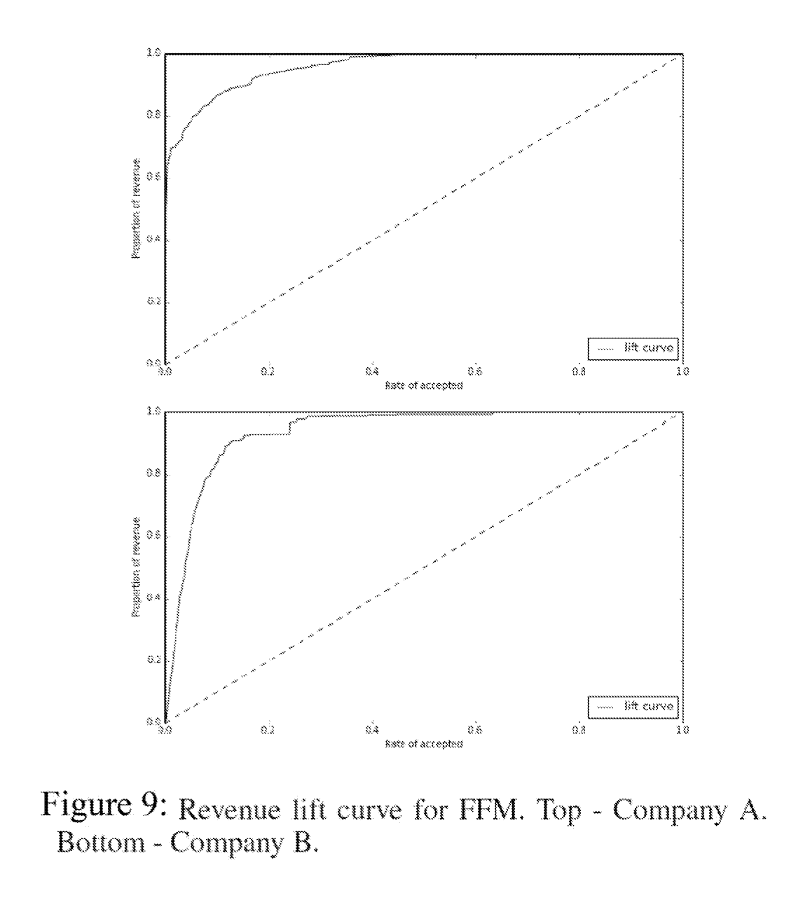

We discuss the straight lines on the right of the lift curves for company A in the next section, “Comparison between DQM and FFM.” FIG. 9 shows the revenue lift curve for FFM for the same experiment.

In the conversion and closed lift curves, we see an interesting behavior in company A, where the lift is significantly less in the 50% selected to 95% selected range, than it is in the 95% to 100% selected range. In FIG. 9 we see, however, that the sales in this later range are a very low sales volume. It is often the case that bigger contracts have a lower chance of successful close, but still a higher expected revenue overall.

### Comparison Between DQM and FFM

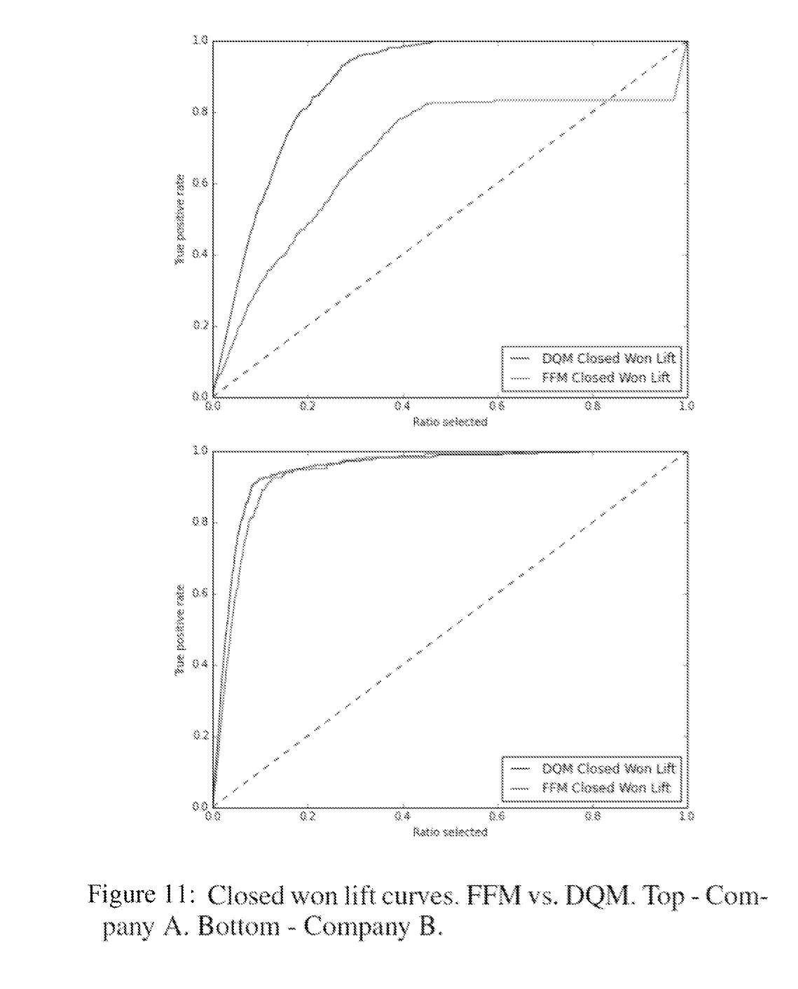

In FIG. 11, we compare the closed won rates for DQM (with (α, β)=(0,1)) and FFM built using all behavioral and static features. As explained in the section “Comment on lift curves” above, the ranking of leads for DQM is based on expected close won rate, and the ranking for FFM is based on expected revenue. Therefore, the closed won curves are better for DQM. This is because the win rate for higher revenue deals may be lower, but the expected revenue is still higher for these deals.

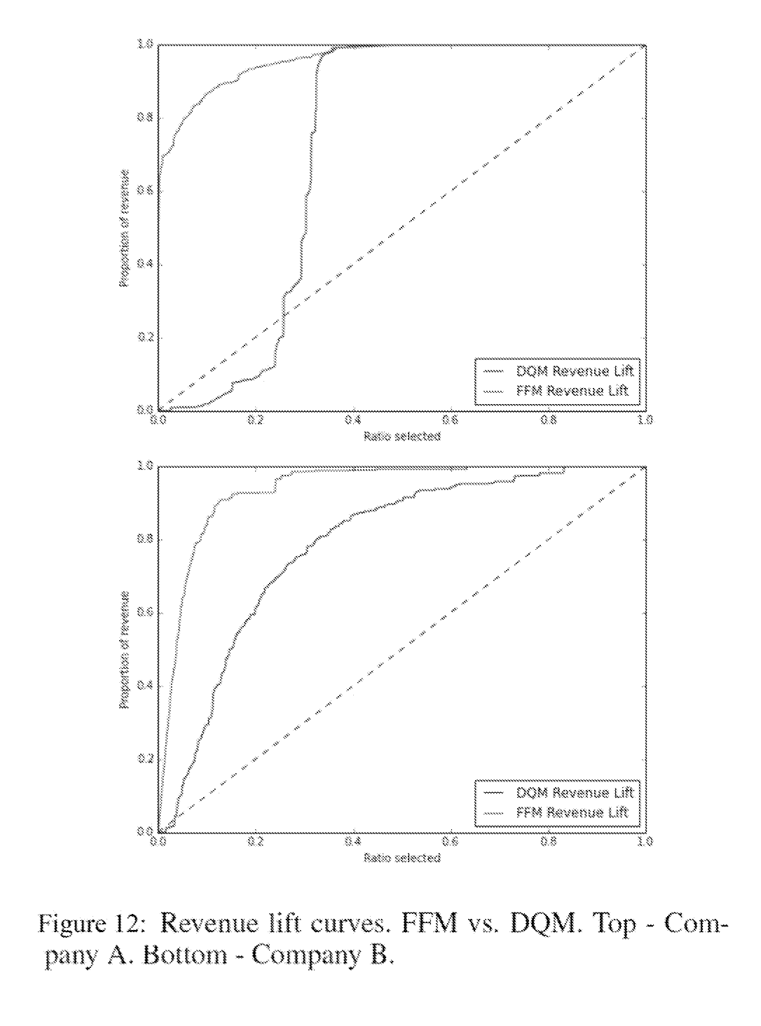

In FIG. 12, we compare revenue lift curves, for the same models. We can see that, for company A, DQM performs poorly at achieving a lift in revenue. This is because it focuses on closing the less risky, lower volume sales. Therefore, DQM should not be used if there is a large amount of variance in the sales price, or separate models should be built for separate products.

In FIG. 11, the straight line in the FFM curve for company A suggests that FFM gives the lowest priority to leads that it indicates are very confident to result in a low revenue close won. DQM achieves very high initial close won lift for company A; but, if we examine the revenue curve in FIG. 12, we see that the initial lift is very low, because it has identified low revenue deals. These observations suggest that it is easier to confidently predict the low revenue closes for company A.

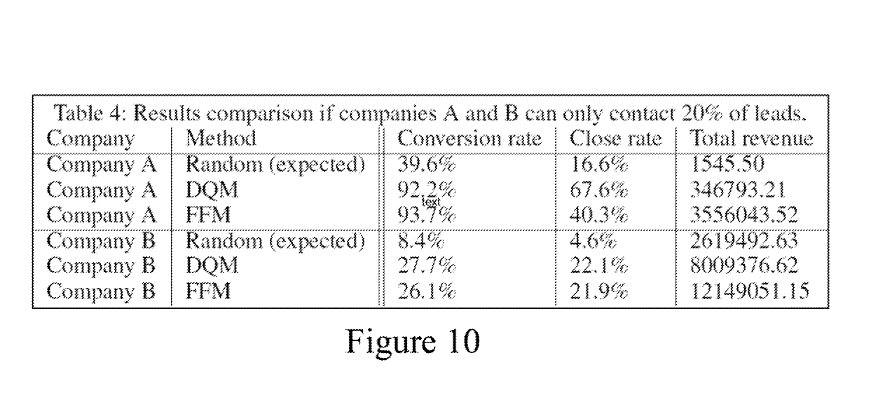

As a final comparison, we assume that the sales team of company A and B only have enough resources to contact 20% of all leads. In Table 4 shown in FIG. 10, we compare the conversion, revenue, and close won rates if the companies prioritize leads randomly, using DQM, and using FFM.

As described in an example embodiment herein, we introduce two methods for modeling a sales funnel, DQM and FFM. In order to add benefit to a sales team, we design these models in such a way that they do not simply relearn a company's existing lead qualification rules, which are error-prone and cannot take into account a large number of features. Instead, we focus on predicting events further along in the sales process, such as likelihood of successful close and expected sales price. Our experiments show that applying our models to actual company data achieve high AUC scores both for classifying lead conversion, and predicting an ultimately successful future sale.

We also demonstrate that the model is predictive whether or not a lead has activity data, which means that the highest quality leads can be identified even before they take actions that can be tracked by the marketing team.

We directly compare the two models and determine that FFM is more desirable if there is more variance in the average sales price (since it can prioritize based on expected sales price), or if lead and opportunity databases cannot be reliably linked.

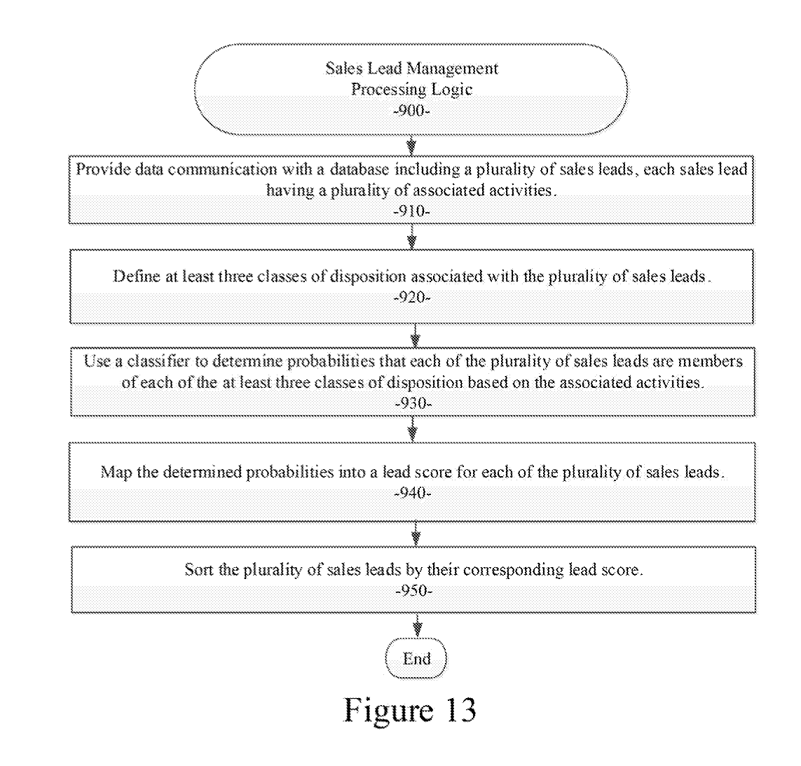

Referring now to FIG. 13, a processing flow diagram illustrates an example embodiment of a sales lead management system 200 as described herein. The method 900 of an example embodiment includes: providing, by a data processor, data communication with a database including a plurality of sales leads, each sales lead having a plurality of associated activities (processing block 910); defining at least three classes of disposition associated with the plurality of sales leads (processing block 920); using a classifier, executable by the data processor, to determine probabilities that each of the plurality of sales leads are members of each of the at least three classes of disposition based on the associated activities (processing block 930); mapping the determined probabilities into a lead score for each of the plurality of sales leads (processing block 940); and sorting the plurality of sales leads by their corresponding lead score (processing block 950).

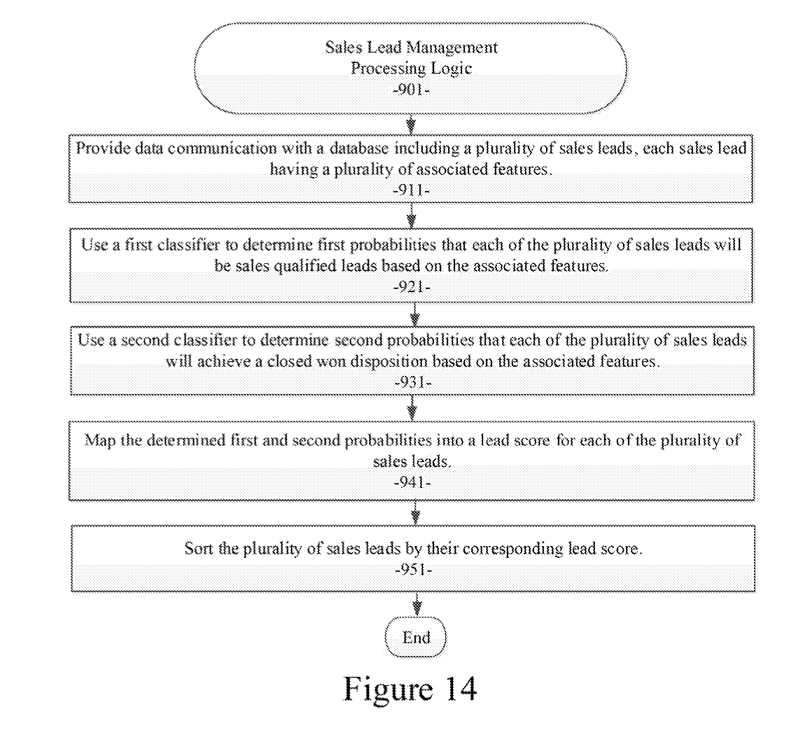

Referring now to FIG. 14, a processing flow diagram illustrates another example embodiment of a sales lead management system 200 as described herein. The method 901 of an example embodiment includes: providing, by a data processor, data communication with a database including a plurality of sales leads, each sales lead having a plurality of associated features (processing block 911); using a first classifier, executable by the data processor, to determine first probabilities that each of the plurality of sales leads will be sales qualified leads based on the associated features (processing block 921); using a second classifier, executable by the data processor, to determine second probabilities that each of the plurality of sales leads will achieve a closed won disposition based on the associated features (processing block 931); mapping the determined first and second probabilities into a lead score for each of the plurality of sales leads (processing block 941); and sorting the plurality of sales leads by their corresponding lead score (processing block 951).

### Using Marketing Automation Activity Data for Lead Prioritization and Marketing Campaign Optimization

Marketing Automation software such as Marketo and Eloqua have become popular for organizing different marketing campaigns over various media channels. These systems also track the interaction of individual leads (potential customers) with the marketing team. For example, such systems record whether leads open an email, visit a webpage, or download a white paper. The large amount of data collected by marketing automation software has potential to be used by machine learning to improve marketing, and therefore also sales. For example, activity counts can be included as features for prioritizing leads based on probability of lead conversion and/or successful sales. In addition, we can learn which marketing campaigns, actions, and assets are more successful at moving leads along in the sales process. This is part of the process of “campaign optimization.”

In the various embodiments described herein, we use this marketing activity data to predict whether or not the lead will be qualified by sales (lead conversion) and whether the lead will result in a successful sale. In order to reduce the feature dimensionality while maintaining key information about activity types and marketing campaigns, we perform topic modeling to represent activities as a mixture over topics. We then use random forest classification to predict the probability of lead conversion and successful sale. In our experiments, the method results in AUC of over 0.877 and 0.884 for predicting conversions and successful sales, respectively, which correspond to a 10.5% and 17.6% improvement over naive activity count features. In addition, we map the topic importances assigned by the classifier, to a “Mean Topic Importance” (MTI) score. We confirm that the relative MTI scores of different activities are intuitive. These MTI scores can be used to give marketing teams information about which marketing campaigns and assets are more important for a lead prioritization model.

### Goals for Predictive Marketing

The success of a marketing team can be measured in different ways. According to a survey at of 116 B2B companies by Predict 2014, 55% of marketing teams measure their own success in terms of brand awareness, website traffic, and lead volume. 25% measure success in terms of number of leads qualified by sales (explained below), and 20% measure success in terms of the number of sales deals closed or total revenue of sales deals closed. On the other hand, sales evaluates the marketing team based on the quality of leads received from marketing (“marketing qualified leads,” or MQLs). As explained above, this is because the MQLs can be thought of as the “output” of marketing and the “input” to the process of “teleprospecting,” wherein teleprospectors will reach out to MQLs to determine if each person meets the minimum criteria for becoming a sales opportunity. If the quality of MQLs are low, the teleprospecting process is particularly time consuming and expensive. The difference in evaluation of marketing success between marketing and sales can result in tension between the two teams. Because the ultimate goal of the sales and marketing is to increase the revenue of the company, marketing teams should measure their success in terms of increasing the number of high quality MQLs. The quality of an MQL should be measured by its likelihood to be qualified by sales, and by its ultimate likelihood to become a successful sale. The sales funnel model described above (see FIG. 2), illustrates how sales and marketing work together to create revenue for the company, and argues that marketing goals should align with the sales team's goals. Therefore, we can combine marketing automation data with historical data about sales qualification and successful sales to build predictive models to improve marketing. We can improve marketing in the following ways:
(1) Improve the marketing team's ability to identify which leads are of higher quality. This problem is called “lead scoring/prioritization”.
(2) Learn which marketing campaigns and assets are most important to the scoring model, and which campaigns bring in the most high quality leads. This information can be used to adjust marketing functions and funds to focus on these types of campaigns, assets, and actions. This problem is called “campaign optimization”.
(3) We would like to build these predictive models without having to perform company-specific text mining on activity data. This would be beneficial to a company such as Fliptop, Inc., which aims to create a flexible lead prioritization solution for any company that uses marketing automation.

### Lead Scoring and Prioritization

As described herein, an important goal of marketing is to deliver quality MQLs to the sales team. According to some sources, only 6% of MQLs will convert to successful sales. This means that the leads that marketing delivers to sales are for the most part of poor quality, and that the marketing qualification process is not good enough at filtering out leads that will not result in sales. For each MQL, teleprospectors must go through a time consuming and expensive qualification process before the leads can be qualified as SQLs. Although many marketing teams measure their success by the number of MQLs, unless the MQLs are of good quality, a large volume will only mean more work for teleprospectors. The sales team could either hire more teleprospectors, or they could instead only focus on the highest quality subset of leads, based on likelihood of a successful sale. Therefore, if we have a model to predict successful sales, lead prioritization can directly benefit both the sales and marketing teams. The marketing team can use the likelihood scores to determine MQLs, and the sales teams can use the scores to prioritize MQLs.

### Campaign Optimization

In addition to scoring leads, we can use machine learning to determine the relative importance of different marketing campaigns, assets, and actions. Marketing can use this information for “campaign optimization,” or improving future marketing campaigns.

### Marketing Automation Activity Data

Many marketing automation systems track interaction between the marketing department and individual leads. Such systems record when marketing batch emails are sent and opened, whether users click links within emails, when a user fills out a form, and whether a user is invited to or attends a webinar, and other activities. We use this data to improve marketing, but it is not immediately clear how to convert such diverse data into meaningful features for a predictive model. As described below, we examine some previous methods for incorporating activity data into lead scoring methods. We then provide new features, which we call activity topic features, for predictive scoring methods.

### Conventional Lead Scoring

As described above, conventional lead scoring has a number of disadvantages. As described in more detail below, these disadvantages can be overcome by the various example embodiments described herein.

### Activity Count Features and Predictive Lead Scoring

Combining the activity count features with a nonlinear, probabilistic model can solve the disadvantages of conventional lead scoring described above. However, deciding how to compute activity counts is not straightforward. Activities can consist of an action type, an asset name, and additional descriptive text or data fields. Examples of action types are: Open Email, Click Email Link, Visit Webpage, and Fill Out Form. An “asset” refers to a particular piece of marketing content created by marketing. An example would be a webinar, a white paper, a marketing email batch, and even roadshows and other events. These assets are each given a text name by marketers. Other fields may include a description or ID fields. This is described in more detail below. However, because of the large number of combinations of activity types, assets, and descriptions, creating a separate count feature for each individual combination results in a very large number of features with poor data coverage. In our experiments, this results in over 10,000 activity counts for “Company B”. Such a large number of features results in over-fitting and poor model performance. Therefore, we combine these counts in various ways. One possibility is to simply group by activity type, and ignore the particular asset. However, this has the disadvantage of losing information that is potentially important for lead prioritization and campaign optimization. For example, we lose the relative importance of different assets, different webpages, and different email campaigns. Therefore, we would still like to group activity counts, but in a more intelligent way that maintains some information about the activity context. For example, we could maintain a separate list of activity counts for each marketing campaign. Marketing campaigns are coordinated activities that can include promotion of a product through different media. For example, one marketing campaign may be geared toward retaining current customers, and involve mostly promotional materials distributed by email. Another campaign may focus on increasing awareness of a product to new customers, and focus on web advertising and social media. Grouping activity counts by campaign is difficult in practice, since many companies do not keep their campaigns well organized, and it may be difficult to determine which campaign a particular marketing activity belonged to, without company-specific text mining on various database text fields. For example, one company may have a reliable database field to hold the campaign name, while another may place the campaign name at the beginning of a generic activity name field, and another may store this field in the middle of a generic activity name field. In addition, if the marketing campaign is absent, we would still like to be able to group similar counts based on shared terms, for example, in the activity description. Because each company is different, and because we want to avoid company-specific text mining, we developed another solution to constructing activity features, called activity topic features.

### Extracting Activity Topic Features

For extracting features from activity data, we take a more general and flexible definition of feature counts (feature counts are described above). We no longer require that an activity contribute to only one count. For example, an “Open Email” activity for a webinar event can contribute both to an “Open Email” count feature and a “Webinar” count feature. We also allow these “counts” to be real numbers instead of integers. So, in the above example, the activity could contribute 0.5 (half) to an “Open Email” feature and 0.5 (half) to a “Webinar” feature. If we allow this more general type of activity feature, it becomes natural to represent activities as a mixture of topics extracted by unsupervised topic modeling. This is because each activity has many text fields, and can be thought of as a text document, and because these topic mixture features correspond to real-valued vectors that sum to 1. Therefore, we represent each activity using a vector of fixed length T, where T corresponds to the number of topics. The ith entry corresponds to the percent of words in the activity document that belong to topic i. This method allows flexibility in the number of features we can add to our model. Additionally, the model is able to incorporate new campaigns and new assets without having to add new features. During scoring, we can still compute a mixture feature for unseen activities, and the model will pick up on any similarities to previous activities encountered in training based on shared words.

### Raw Activity Data

As described above, activity data consists of an action type, an asset name, and a text description field. Different companies may have different activity types, but most activity types are shared and provided by marketing automation, such as email actions, website visit actions, and fill out form actions. Additionally, activities such as “Interesting Moment,” are customizable by the marketing team, and fire when a lead performs a specific action identified by the team as important, such as downloading a particular white paper, or visiting the website twice in one week. These activity data fields are mostly text fields, either filled out manually by the marketing team, or automatically by marketing automation. For example, each activity has an asset name field. For email activities, this may or may not be equal to the email subject. The campaign name is sometimes included in the asset name field, and sometimes in a separate field. Activities, such as “Interesting Moment,” include an additional text description field, which give more information about the action taken. Some activities include numeric IDs, such as Click Link and Visit Webpage, which have a webpage ID field. The webpage address is also stored as text in the name field. Specific activity fields will be examined in more detail in the experiments described below.

### Constructing Activity “Documents” and BOW Vectors

In order to construct documents for each activity, we concatenate several text fields together, each separated by a space: the activity type, name, and description fields. We then discard any duplicate documents resulting from the training set. After this, we convert each document to a list of words, by separating the document string by whitespace and periods. We then remove the following stop words: ‘−’, ‘in’, ‘that’, ‘and’, ‘and’, ‘the’, ‘by’, ‘a’, ‘to’, ‘for’, ‘or’, ‘at’, and ‘from’. We convert each resulting document to bag of words (BOW) feature vectors, where each entry i corresponds to the number of times word i appears in the document. There is an entry i for each individual token in the training set.

Topic Modeling with LDA

From these activity documents, we perform unsupervised learning to discover topics using latent dirichlet allocation (LDA). LDA is a well-known technique (e.g., see Blei, D. M., Ng, A. Y., Jordan, M. I.: Latent dirichlet allocation, “Journal of Machine Learning Research 3”, 993-1022 (2003)). We chose T=40, where T is the number of topics. This worked well in our experiments. We then use the learned LDA model to represent each activity document as a mixture over the different topics. It results in a vector of length T for each individual activity document, with entries summing to 1. We compute BOW features and perform LDA using the gensim library (e.g., see Rehurek, R., Sojka, P.: Software Framework for Topic Modelling with Large Corpora, In: Proceedings of the LREC 2010 Workshop on New Challenges for NLP Frameworks, pp. 45-50. ELBA, Valletta, Malta (May 2010), http://is.muni.cz/publication/884893/en).

### Training the LDA Model

In an example embodiment, the LDA model can be trained using the following process. For each activity in the training set, we can concatenate desired text fields together to create activity documents. Then, we can construct a dictionary from the words in these activity documents. Then, we can convert each unique activity in the training set into a BOW vector using the dictionary, and ignoring stop words. Finally, we can train the LDA model using these BOW vectors, wherein the trained LDA model is provided as the output.

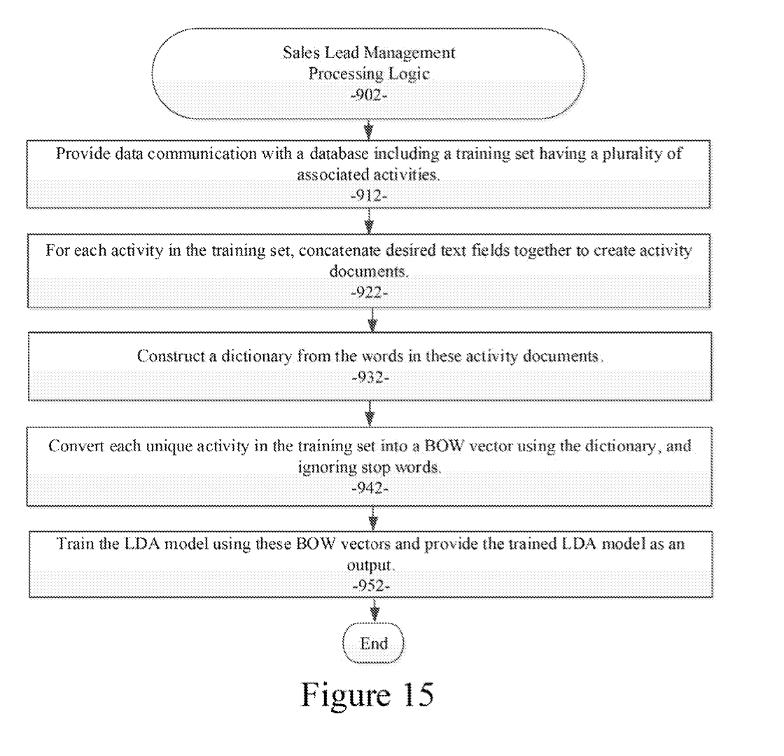

Referring now to FIG. 15, a processing flow diagram illustrates another example embodiment of a sales lead management system 200 and the LDA model training as described herein. The method 902 of an example embodiment can be configured to: provide data communication with a database including a training set having a plurality of associated activities (processing block 912); for each activity in the training set, concatenate desired text fields together to create activity documents (processing block 922); construct a dictionary from the words in these activity documents (processing block 932); convert each unique activity in the training set into a BOW vector using the dictionary, and ignoring stop words (processing block 942); and train the LDA model using these BOW vectors and provide the trained LDA model as an output (processing block 952).

### Calculating Activity Features for Each Lead

In an example embodiment, the activity features for each lead can be calculated using the following process. For each lead, we can compute an activity document for each activity (e.g., by concatenating desired text fields together to create activity documents as described above). Then, we can compute the BOW vectors using the dictionary, ignoring stop words. Then, we can use the LDA model to compute a mixture over topics for each activity (this is a T length vector, whose entries sum to 1). Then, we can sum each of the T length vectors, resulting in T=40 features for each lead. Finally, these features can be added to the other features and used to train the model as normal (e.g., leads in the training and the testing set, and any other future leads scored by the model).

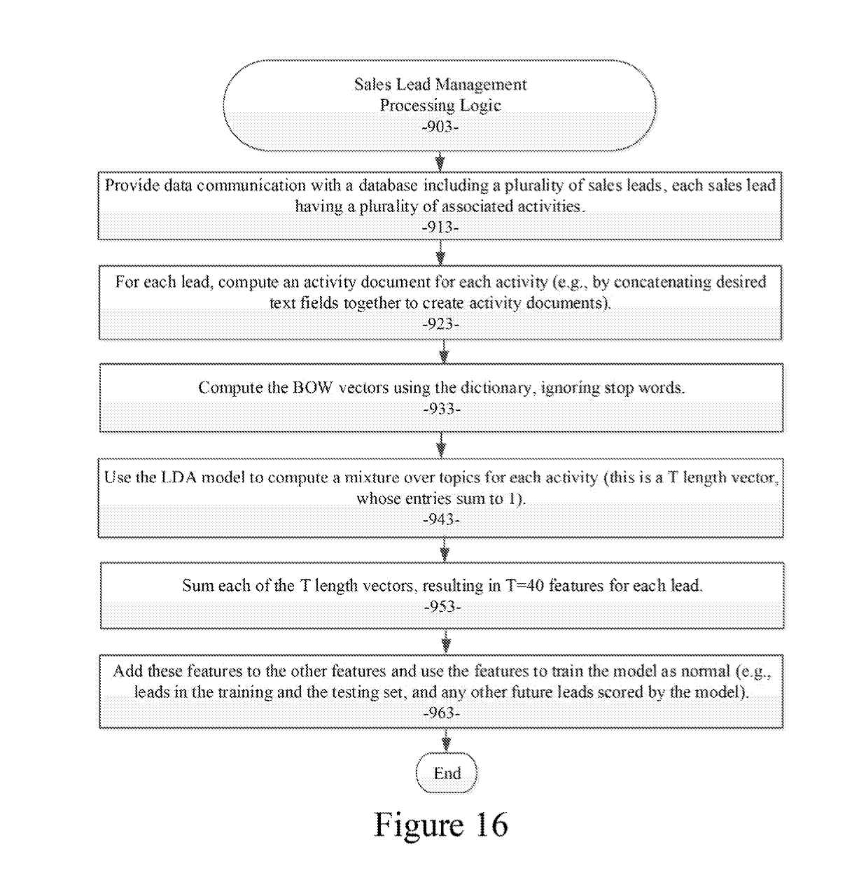

Referring now to FIG. 16, a processing flow diagram illustrates another example embodiment of a sales lead management system 200 and the activity feature calculation as described herein. The method 903 of an example embodiment can be configured to: provide data communication with a database including a plurality of sales leads, each sales lead having a plurality of associated activities (processing block 913); for each lead, compute an activity document for each activity (e.g., by concatenating desired text fields together to create activity documents) (processing block 923); compute the BOW vectors using the dictionary, ignoring stop words (processing block 933); use the LDA model to compute a mixture over topics for each activity (this is a T length vector, whose entries sum to 1) (processing block 943); sum each of the T length vectors, resulting in T=40 features for each lead (processing block 953); and add these features to the other features and use the features to train the model as normal (e.g., leads in the training and the testing set, and any other future leads scored by the model) (processing block 963).

### Lead Topic Features

In order to do lead prioritization, we need to compute a feature for each lead, rather than for each activity. This feature should represent all the activity for that lead during some time period. In order to compute a lead feature, we find all activities performed by that lead during the time interval (C(l)−h,C(l)), and sum the corresponding activity topic features. C(l) is the time when lead l is qualified by sales, if l converted, and the timestamp of the most recent activity otherwise. h is the time horizon parameter, in the example embodiment, three months.

### Lead Prioritization Method

The problem of lead scoring or prioritization is ranking leads based on probability of a lead to become a successful sale. To perform lead prioritization, we compute lead topic features for all leads and assign each lead one of three labels:
NoCON: Leads that never convert,
LOST: Leads that convert to opportunities that are ultimately lost, and
WON: Leads that convert to opportunities that successfully close (closed won).

We then perform classification using a random forest classifier. Leads are prioritized based on the probability of conversion or successful close. In the various embodiments disclosed herein, we prioritize based on successful close.

### Constructing Training and Testing Sets

After computing lead features, we split the set of leads between training and testing sets. The training set contains 75% of the data, and the testing set contains 25% of the data. We only use leads that converted in the last year, or that had activity in the last year.

### Random Forest Classification

We use a 3-class random forest classifier. The use of random forest classifiers are well-known in the art. The Gini impurity index is used to determine tree splits. For the disclosed example embodiments, we use a conventional random forest classifier implementation, with 1000 trees and an unlimited tree depth.

### Mean Topic Importance Scores for Campaign Optimization

For campaign optimization, marketing teams need feedback about which of their campaigns result in generating the most quality leads, and which activities and assets are the most important for lead prioritization. We can use a predictive lead scoring model (such as the one described above), to determine the effectiveness of marketing campaigns. For example, marketing teams can look at the average predicted conversion or close rates for each campaign, and learn which types of campaigns have generated the highest quality leads. In order to learn the relative importances of different activities, we can make use of the feature importances returned by the lead scoring classifier. These importances can be used to identify the features that are more important to the model. In the example of a random forest classifier, we compute variable importances using well-known classification and regression techniques. The importance score of a variable v can be thought of as roughly the proportion of samples that reach a decision node over variable v, averaged over all trees in the ensemble.

Because we are using topic features, the feature importances do not directly map to activities, but to topics. Because topics are learned with an unsupervised algorithm, they may not directly match with marketing concepts, such as asset or activity type. For example, in our experiments, one of the topics represents roadshow location (Los Angeles, Denver, etc.). In order to allow marketing teams to compare the importance of two arbitrary activities, whether or not they correspond to exact topic features, we convert topic importance scores to individual activity scores, by computing a “mean topic importance” (MTI) score according to the sample process for calculating a mean topic importance score set forth below. In our experiments, we see that the MTI score gives intuitive importance scores for individual activities.

Calculating Mean Topic Importance Score

Input: Activity document d

Input: LDA Model LDA

Function ƒ: N→R, a mapping from variable number i to variable importance score ƒ(i).

Convert the activity document d to a topic vector x, according the LDA model:
for each entry xi in the topic vector, corresponding to topic i, compute:
do

sᵢ=vᵢ*ƒ(i)
Return s, the average of the sᵢ's. This is the MTI of d.

end for

### Experiments in an Example Embodiment

In an example embodiment, experiments were performed with the example embodiment on data from a sample company, “Company B,” a publicly owned software company. The table set forth below includes data specifying the training and test sets used in the experiments. For each of the leads in the test set, we have at most 212 day's worth of activity information. For leads in classes WON and LOST, we only consider activities that were performed before lead conversion, to prevent data leakage.

| Set | NoCON | LOST | WON |
|---|---|---|---|
| Training | 5160 | 275 | 51 |
| Test | 1712 | 104 | 13 |
| Total | 6872 | 379 | 64 |

Company B, in the experiments, has a total of 911 individual activity documents (excluding duplicates), which were used to train a dictionary and LDA model. The activity types are given in the list below.

1. Click Email

2. Click Link

3. Click Sales Email

4. Email Bounced

5. Email Bounced Soft

6. Email Delivered

7. Fill Out Form

8. Interesting Moment

9. Open Email

10. Visit Webpage

### Lead Prioritization

Our lead prioritization experiment described above resulted in an AUC of 0.877 for predicting lead conversion and an AUC of 0.884 for predicting successful sales. For calculating the ROC curve for conversions, we used the predicted probabilities for classes WON and LOST and classified vs. class NoCON. For the ROC curve for successful sales, we used predicted probabilities for WON and classified vs. the class [NoCON or LOST].

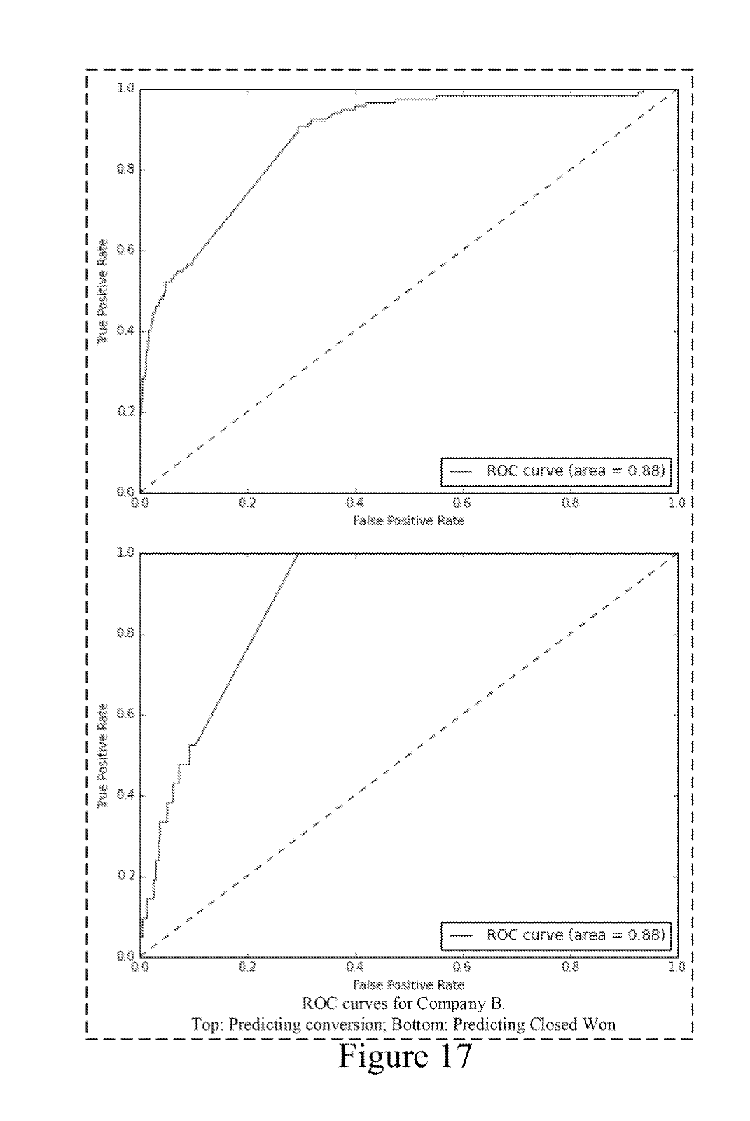

FIG. 17 shows the resulting ROC curves. In these figures, the sloped line that occurs from around 0.15 to 0.25 in the x-axis corresponds to leads with no activity features. These are not distinguishable by our features, so we draw a sloped line to represent the average of possible ROC curves through this region. In order to distinguish between these leads, we should add additional non-activity features that represent the demographic fit between a company and its potential customers.

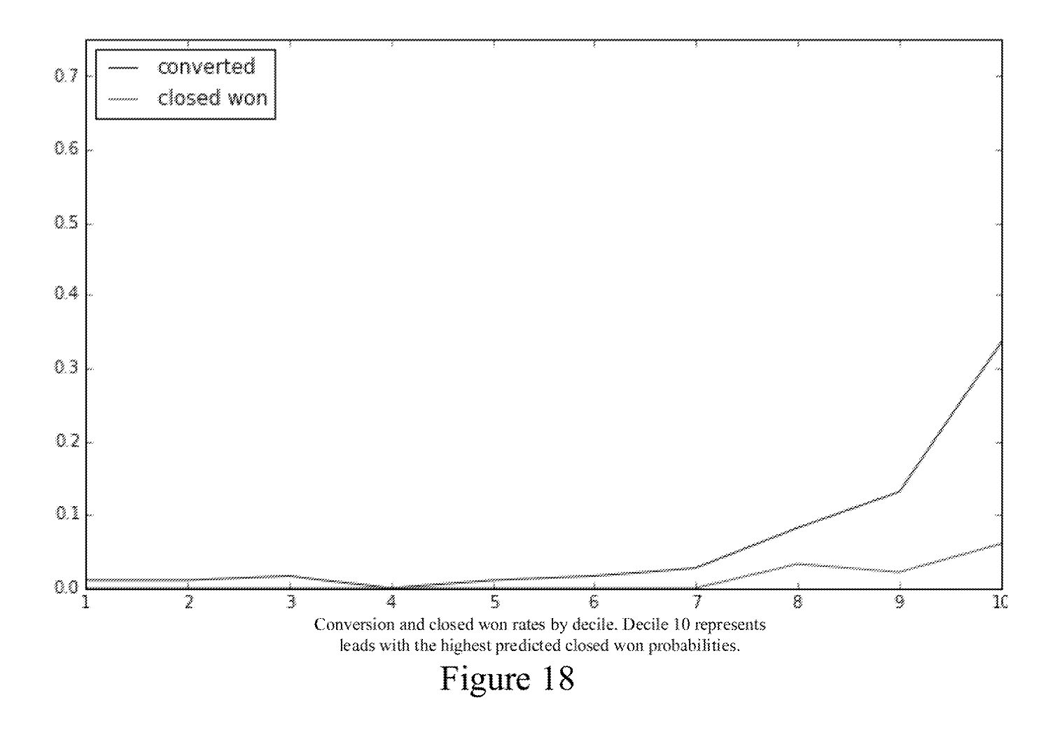

FIG. 18 shows the conversion and closed won rates if we group them into deciles based on the predicted probability of closed won. We see that if Company B's sales team only pursues the top 30% of leads predicted by our methods, they will call all of the leads that will ultimately result in a sale.

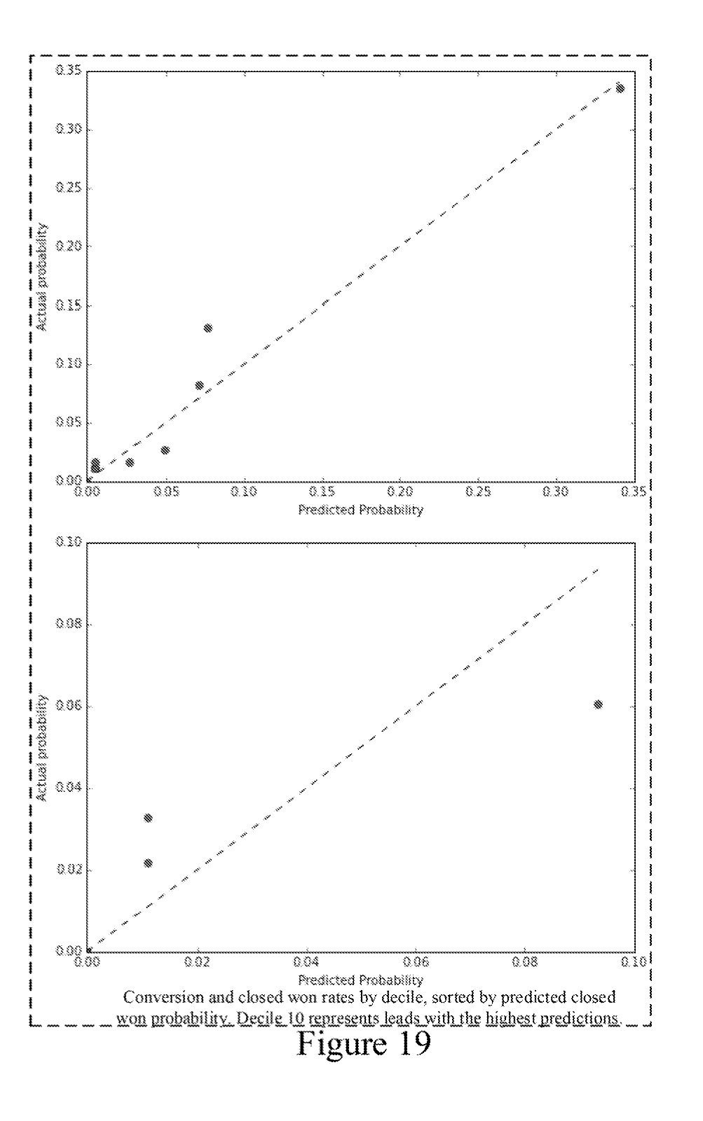

FIG. 19 shows the calibration of probabilities within the deciles. We compare our results to naive features computed by simply taking counts of each activity type. This results in 10 feature counts, corresponding to the activities list given above. Using these features with the same random forest classifier results in an AUC of 0.794 for predicting conversions and an AUC of 0.752 for predicting successful sales. Therefore, the topic features achieve an improvement of 10.5% and 17.6% over the naive features, for predicting conversions and successful sales, respectively.

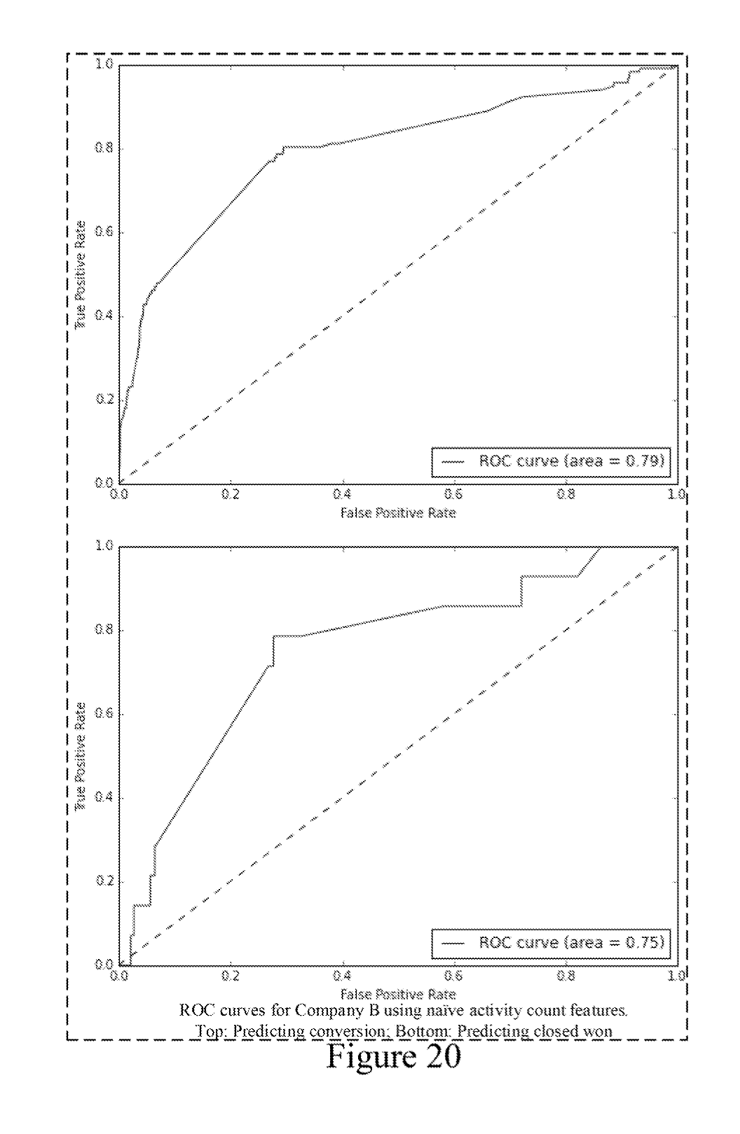

In FIG. 20, we give the ROC curves for the naive activity features. In these figures, there are a greater number of sloped regions, which show that these features are less successful at distinguishing between different leads than the topic features.

### Activity Scores

As described above, topics are not necessarily easily understood by marketing teams. We therefore convert topic importances returned by our model to a per-activity MTI score. Having a score per activity allows the marketing team to examine which activities, and assets are important to the model. Therefore, per-activity scores are actionable metrics that marketing can use when creating new marketing content, and when interacting with leads.

In this section we look at some of the signals, and show that their importance scores match with the importance predicted by the marketing team. In the example presented herein, the marketing team of Company B has identified visits to the pricing pages to be key buying signs. Our model identified these pricing page visits as two of the three most important Click Link activities. Additionally, visiting the pricing page was the second most important Visit Webpage activity.

The marketing team also identified a set of interesting moments as being particularly important to their marketing team. Our model found that 8 out of 10 of the top activity signals were interesting moments. However, this was not simply because an interesting moment topic was given high importance; the rest of the interesting moments are roughly evenly distributed throughout the activities when ranked by their MTI score. The top two interesting moments are opening sales emails, which indicate that the users would be responsive to contacts from sales. The next most important interesting moment is opening a follow up email about a product trial request, followed by frequent web visits (twice per week). Next, we see an unregistering interesting moment, which is an important negative indicator.

The example embodiments described herein provide a novel technique for incorporating marketing activity data into predictive marketing models for lead prioritization and campaign optimization. A main benefit of these activity topic features is that unsupervised topic modeling allows features to be computed without requiring time-consuming company-specific text mining. In addition, the model is flexible in avoiding over-fitting issues resulting from too many activity counts, as the number of topics can be adjusted. Our experiments on actual marketing data show that these features are effective in lead prioritization, with AUC scores of over 0.8. We also explain how to compute an activity importance score, called MTI score. MTI scores and campaign-based lead prioritization scores can help marketing teams in performing campaign and asset optimization, identifying successful assets and campaigns, and adjusting future marketing functions based on this information. In our experiments, MTI scores were able to recognize as important key interesting moments and buying signs identified by the marketing team.

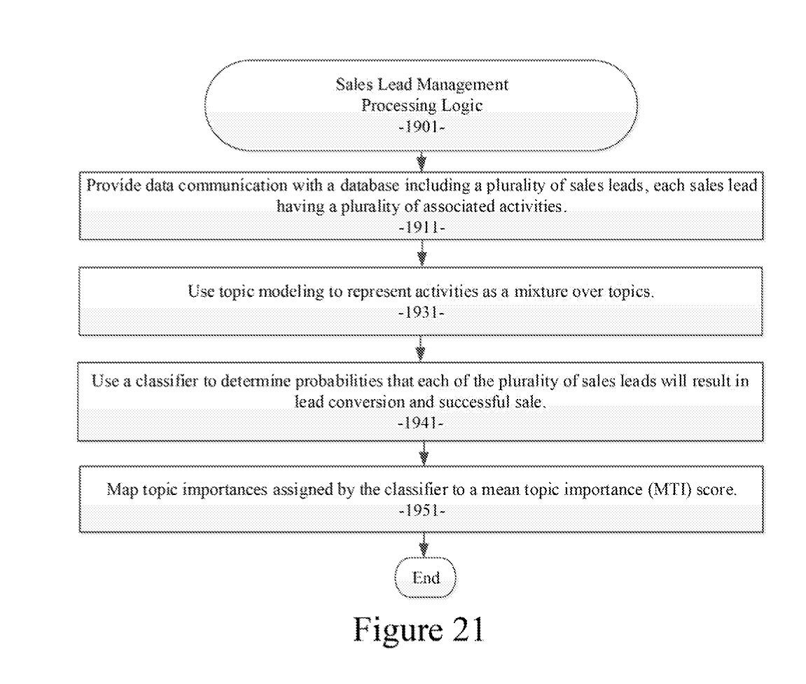

Referring now to FIG. 21, a processing flow diagram illustrates another example embodiment of a sales lead management system 200 as described herein. The method 1901 of an example embodiment includes: providing, by a data processor, data communication with a database including a plurality of sales leads, each sales lead having a plurality of associated activities (processing block 1911); using topic modeling to represent activities as a mixture over topics (processing block 1931); using a classifier to determine probabilities that each of the plurality of sales leads will result in lead conversion and successful sale (processing block 1941); and mapping topic importances assigned by the classifier to a mean topic importance (MTI) score (processing block 1951).

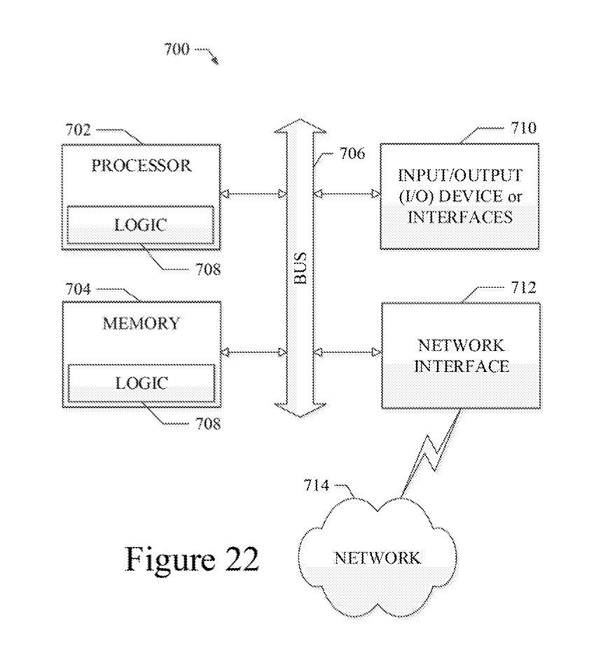

FIG. 22 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, Bluetooth, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A system comprising:
a data processor;
a database, in data communication with the data processor, the database including a plurality of sales leads, each sales lead having a plurality of associated activities; and
a sales lead management system, executable by the data processor, to:
use topic modeling to represent activities as a mixture over topics;
use a classifier to determine probabilities that each of the plurality of sales leads will result in lead conversion and successful sale; and
map topic importances assigned by the classifier to a mean topic importance (MTI) score.

2. The system of claim 1 wherein the plurality of sales leads are classified into at least three classes of disposition from the group consisting of: leads that never convert (NoCON), leads that convert to opportunities that are ultimately lost (LOST), and leads that convert to opportunities that successfully close or are closed won (WON).

3. The system of claim 1 being further configured to train the classifier on a training set of sales leads.

4. The system of claim 1 being further configured to map the determined probabilities into a lead score by performing a linear combination of the determined probabilities.

5. A method comprising:
providing, by a data processor, data communication with a database including a plurality of sales leads, each sales lead having a plurality of associated activities;
using topic modeling to represent activities as a mixture over topics;
using a classifier to determine probabilities that each of the plurality of sales leads will result in lead conversion and successful sale; and
mapping topic importances assigned by the classifier to a mean topic importance (MTI) score.

6. The method of claim 5 wherein the plurality of sales leads are classified into at least three classes of disposition from the group consisting of: leads that never convert (NoCON), leads that convert to opportunities that are ultimately lost (LOST), and leads that convert to opportunities that successfully close or are closed won (WON).

7. The method of claim 5 including training the classifier on a training set of sales leads.

8. The method of claim 5 wherein mapping the determined probabilities into a lead score includes performing a linear combination of the determined probabilities.
